(19) United States
(12) Patent Application Publication
(10) Pub. No.: US 2007/0014898 A1
(43) Pub. Date: Jan. 18, 2007

(54) Polymeric cereal container as well as system and method utilizing same

(75) Inventors: J. Evan Spirk, Gates Mills, OH (US); Craig M. Saunders, Rocky River, OH (US); Patrick Brown, Mantua, OH (US); John Spirk, Gates Mills, OH (US); John R. Nottingham, Bratenahl, OH (US); Wilson Pan, Cleveland, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Nottingham-Spirk Design Associates, Inc.

(21) Appl. No.: 11/485,516

(22) Filed: Jul. 12, 2006

Related U.S. Application Data
(60) Provisional application No. 60/595,517, filed on Jul. 12, 2005.

(51) Int. Cl. A23B 7/148

(52) U.S. Cl. 426/106

(57) ABSTRACT

A polymeric cereal container includes a first wall, a cereal chamber at least partially formed by the first wall, and a container opening at least partially defined by the first wall. A first quantity of dry cereal can be received within the cereal chamber, and a second quantity of dry cereal can be provided separately. A method can include providing and filling a polymeric cereal container with a quantity of dry cereal. A system can operate to fill a polymeric cereal container with a quantity of dry cereal.

### BACKGROUND

The present novel concept broadly relates to the art of food packaging and, more particularly, to a polymeric container for storing dry cereal and a system and method of packaging dry cereal using the same.

Dry cereal is a popular food item that is often consumed as a part of a meal or as a snack. For example, cereal can be eaten as a breakfast food served in a bowl with milk. Additionally, cereal is commonly eaten as a snack food without milk and is often consumed directly from the package. Dry cereal is sold in great quantities, and much of the dry cereal is packaged and sold to consumers in rectangular cardboard boxes. Typically, the dry cereal is sealed within a plastic bag that is received within the cardboard box. Text and graphics of various sorts are printed on the box to identify the cereal and the manufacturer, as well as to provide nutritional and other information. Furthermore, the boxes are often printed with market-appropriate information, promotional materials and/or other marketing items, such as games and activities for children, for example.

Though such packaging is very common, there are numerous difficulties, inconveniences and/or disadvantages associated with its continued use. One example of such a disadvantage is associated with re-closing the cereal package after the cereal product has been dispensed or consumed therefrom. To fully illustrate the inconvenience to consumers, it will be beneficial to first briefly describe the construction of the cardboard box and plastic bag of usual packaging arrangements.

Typically, the cardboard box is formed from a cardboard blank. Though the blank can be formed in any suitable manner, the same are often cut from a sheet of cardboard material using a die or other suitable device. The rectangular body of the box is constructed by folding the blank in numerous places and adhering together two opposing edges thereof. Flaps located at each of the opposing ends of the box body are then folded over and adhered to one another to form the fully enclosed package.

Due, at least in part, to this method of construction, it is difficult and expensive to manufacture cardboard boxes in anything other than rectilinear shapes, such as squares or rectangles. The sealed plastic bag that contains the cereal can be deposited within the cardboard box at any one of a number of steps or stages of the box assembly process, with the end result being that the plastic bag of cereal is sealed within the box. The plastic bag is used to prevent contamination of the cereal product by the cardboard material and also provides improved sealing of the package. The plastic bag is in direct contact with the cereal products, so a material approved for food contact is normally used. To access the cereal located therein, the consumer permanently opens the box by tearing apart two adhesively secured flaps at one end of the box and then permanently tearing open the polymeric bag to get to the cereal product.

One of the problems associated with opening packaging that has been formed in this manner is that positive re-closure of the package is not assured. First, the plastic bag that contains the cereal is typically not self-sealing. So, the consumer will roll-up or crush-up the open end of the bag in an attempt to close the opening that was previously torn therein. Being formed from a plastic material, however, the bag does not retain this rolled-up shape and normally unrolls a substantial amount.

Additionally, the two flaps that were initially torn apart to access the plastic bag typically include interlocking features, such as a tab on one flap and an opposing slit on another flap, for example, that can be used to attempt to re-close the box. After rolling up the open end of the bag, the consumer will close the two flaps and try to interlock the features to close the box. Unfortunately, flaps secured in this manner, along with the rolled-up bag, do not offer a significant barrier to the ingress of moisture or any significant level of protection against insects, both which are undesirable and can present severe problems in certain geographic areas.

Furthermore, to minimize costs associated with packaging the cereal product, very thin cardboard material is often used for the box. This presents a number of disadvantages and adds to the difficulties associated with re-closing the packaging, as well. For example, the flaps of the box are often inadvertently ripped or otherwise damaged when the box is initially opened, unless substantial care is exercised. This is due, at least in part, to the thinness and/or reduced strength of the cardboard material. This results in the flaps not re-closing securely and, thus, providing access for moisture and/or insects. Because of the increased flexibility of this thin material, the box tends to flex or swell at its midpoint due to the settling of the cereal. This can be particularly problematic for the consumer once the package has been opened, because the flaps of the box are pushed apart or otherwise separated from one another, often to the point that the interlocking features will not properly engage one another. As a result, known cereal boxes are often incapable of being properly and securely closed after being initially opened.

Another disadvantage of the current bag-in-box packaging is that the rolled or crumpled bag and the flaps of the box do not allow for easy or convenient access to the cereal product for the purpose of direct consumption, such as during snacking, for example. Furthermore, the crumpled bag and the box flaps and edges do not provide for easy or convenient pouring of the cereal product, such as into a bowl, for example. This can be particularly problematic for younger children, for whom many types and kinds of cereal are intended. One reason for this is that children tend not to fully unroll or otherwise open the crumpled bag, which can create an opening and/or surface that is not well suited for pouring the cereal. In many cases, the child will then tip the box to a greater degree to cause the cereal to flow from the bag. This, in turn, can lead to a rush of cereal flowing toward the opening, often resulting in spillage or waste of the cereal product.

Still another disadvantage of current bag-in-box packaging arrangements for cereal products is that the packaging is not reusable. That is, current boxes are not sufficiently durable for use as a refillable container for cereal products. Similarly, the typical bag-in-box package is not sufficiently durable or otherwise suitable for usage as a storage container for other products or household items. Furthermore, the secondary uses for such cardboard boxes are generally limited to single-use activities for children, such as puzzles, games or coloring activities, for example. As a result, the entire bag-in-box package is typically disposed of once the cereal product therein has been consumed.

Furthermore, promotional items, such as small books, stickers, activity boards, coupons, toys and compact discs, for example, are often included within known packages of cereal for marketing and promotional purposes. A further disadvantage of typical packaging arrangements is that the promotional item must itself be separately packaged to prevent any inadvertent contamination of the cereal product due to the inclusion of the promotional item within the cereal package. Further still, the item and its separate wrapper are normally designed and arranged such that damage to the cereal product or penetration of the plastic bag and/or cardboard box does not result from the transport and handling of the cereal box prior to purchase and opening by the consumer. This can place constraints on the type, size and/or shape of the items that can be included or used as promotional items, and can increase the costs associated with the inclusion thereof. What's more, since the promotional items can vary greatly in size and shape, circumstances arise in which production equipment is not suited for and/or capable of inserting the promotional item into the packaging in the proper manner. This can lead to off-line processes that can significantly increase the costs associated with including the promotional items.

### BRIEF DESCRIPTION

A linerless cereal container is provided in accordance with the present novel concept that includes a first side wall formed from a polymeric material and includes a first opening wall portion. A second side wall is formed from the polymeric material and is spaced from the first side wall and at least partially defines a cereal chamber therebetween. The second side wall includes a second opening wall portion spaced from the first opening wall portion and at least partially defines a container opening therebetween. At least one end wall is formed from the polymeric material. The at least one end wall extends between the first side wall and the second side wall, and includes-an end opening wall portion extending between the first and second opening wall portions. A bottom wall is formed from the polymeric material and extends between at least two of the first side wall, the second side wall or the end wall.

A cereal container storing a quantity of dry cereal in accordance with the present novel concept is provided and includes a container body formed from a rigid polymeric material. The container body includes a first side, a cereal chamber at least partially formed by the first side and receiving the quantity of dry cereal, and a container opening at least partially defined by the first side. A container cap is formed from a rigid polymeric material and includes a closed end, an opposing open end and a side wall extending between the open and closed ends. The container cap is received on the container body such that the closed end extends across at least a portion of the container opening. A sealing member either extends across at least a portion of the container opening between the container body and the container cap or extends along the side wall of the container cap.

A method of packaging cereal in accordance with the present novel concept is provided and includes a step of providing a cereal container formed from a polymeric material. The cereal container includes a first wall, a cereal chamber at least partially formed by the first wall and a container opening at least partially defined by the first wall. Another step includes providing a quantity of cereal and dispensing the quantity of cereal into the cereal chamber of the cereal container through the container opening. Further steps include providing a container cap formed from a polymeric material, and securing the container cap on the cereal container across at least a portion of the container opening.

A cereal packaging system in accordance with the present novel concept includes a cereal product source adapted to output a quantity of a cereal product. A polymeric cereal container source is adapted to output a polymeric cereal container that includes a first wall, a cereal chamber at least partially defined by the first wall and a container opening at least partially defined by the first wall. A filling station in communication with the cereal product source and the polymeric cereal container source respectively receives the quantity of cereal product and the polymeric cereal container. The filling station is adapted to dispense the quantity of cereal product into the cereal chamber of the polymeric cereal container through the container opening. A sealing member source is adapted to output a sealing member. A container sealing station is in communication with the filling station and the sealing member source to respectively receive a filled polymeric cereal container and the sealing member. The container sealing station is adapted to apply the sealing member along the filled polymeric cereal container. A container cap source is adapted to output a polymeric container cap, and a capping station is in communication with the container sealing station and the container cap source to respectively receive a sealed polymeric cereal container and the container cap. The capping station is adapted to secure the container cap on the sealed polymeric cereal container.

A cereal container assembly in accordance with the present novel concept is provided and includes a first quantity of dry cereal and a first container body formed from a rigid polymeric material. The first container body includes a first side, a cereal chamber at least partially formed by the first side and receiving the first quantity of dry cereal, and a first container opening at least partially defined by the first side. A container cap is formed from a rigid polymeric material and includes a closed end, an opposing open end and a side wall extending between the open and closed ends. The container cap is received on the container body such that the closed end extends across at least a portion of the first container opening. A sealing member one of extends across at least a portion of the first container opening between the container body and the container cap or extends along the side wall of the container cap. A cereal product refill is secured to the container body and includes a second quantity of dry cereal.

A low-cost, linerless cereal container assembly in accordance with the present novel concept for storing an associated quantity of dry cereal is provided and includes a container including a container wall formed from a first thin-walled polymeric material. The container wall at least partially defines a cereal chamber for receiving the associated quantity of dry cereal. The container wall includes an opening wall portion that at least partially defines a container opening that provides access to the cereal chamber. A container cap includes a cap wall formed from a second thin-walled polymeric material. The container cap is received on the container such that the cap wall extends across at least a portion of the container opening. A sealing member is formed from a third thin-walled polymeric material. The sealing member is one of disposed across at least a portion of the container opening or extended along the cap wall of the container cap.

### BRIEF DESCRIPTION OF THE DRAWINGS

FIG. 1 is a front perspective view of one exemplary embodiment of a polymeric cereal container in accordance with the present novel concept.

FIG. 1A is a rear perspective view of the polymeric cereal container in FIG. 1.

FIG. 2 is an exploded cross-sectional side view of the polymeric cereal container in FIG. 1 taken along line 2-2.

FIG. 3 is an assembled cross-sectional side view of the polymeric cereal container in FIG. 2.

FIG. 4 is an enlarged view of a portion of the polymeric cereal container in DETAIL 4 of FIG. 3.

FIG. 5 is a perspective view of the polymeric cereal container in FIG. 1 together with cereal product refills in bulk packaging.

FIG. 6 is a front perspective view of another exemplary embodiment of a polymeric cereal container in accordance with the present novel concept.

FIG. 7 is a rear perspective view of the polymeric cereal container in FIG. 6.

FIG. 8 is an exploded cross-sectional side view of the polymeric cereal container in FIG. 6 taken along line 8-8.

FIG. 9 is a perspective view of still another exemplary embodiment of a polymeric cereal container in accordance with the present novel concept shown in an open condition.

FIG. 10 is a cross-sectional side view of a portion of the polymeric cereal container in FIG. 9 shown in a closed condition.

FIG. 11 is a perspective view of yet another exemplary embodiment of a polymeric cereal container in accordance with the present novel concept shown in an open condition.

FIG. 12 is a cross-sectional side view of a portion of the polymeric cereal container in FIG. 11.

FIG. 13 is a cross-sectional side view of the portion of the polymeric cereal container in FIG. 12 shown in a closed condition.

FIG. 14 is a perspective view of a further exemplary embodiment of a polymeric cereal container in accordance with the present novel concept shown in an open condition.

FIG. 15 is a cross-sectional side view of a portion of the polymeric cereal container in FIG. 14 shown in a closed condition.

FIG. 16 is a perspective view -of still a further exemplary embodiment of a polymeric cereal container in accordance with the present novel concept.

FIG. 17 is a perspective view of yet a further exemplary embodiment of a polymeric cereal container in accordance with the present novel concept shown in an open condition.

FIG. 18 is a perspective view of the polymeric cereal container in FIG. 17 shown in a closed condition.

FIG. 19 is a perspective view of another exemplary embodiment of a polymeric cereal container in accordance with the present novel concept.

FIG. 20 is a perspective view of still another exemplary embodiment of a polymeric cereal container in accordance with the present novel concept shown in a closed condition.

FIG. 21 is a perspective view of the outer container portion of the polymeric cereal container in FIG. 20 shown in an open condition.

FIG. 22 is a perspective view of yet another exemplary embodiment of a polymeric cereal container in accordance with the present novel concept shown in a closed condition.

FIG. 23 is a perspective view of the outer container portion of the polymeric cereal container in FIG. 22 shown in an open condition.

FIG. 24 is a perspective view of one exemplary embodiment of a polymeric cereal container in accordance with the present novel concept suitable for use as an inner container portion in association with the outer container portions in FIGS. 21 and 23.

FIG. 25 is a perspective view of the polymeric cereal container in FIGS. 22 and 23 and numerous ones of the polymeric cereal container in FIG. 24 packaged together.

FIG. 26 is a perspective view of numerous ones of the polymeric cereal container in FIG. 24 packaged together.

FIG. 27 is a cross-sectional side view of one exemplary embodiment of a polymeric multi-material wall structure.

FIG. 28 schematically illustrates one exemplary embodiment of a system for packaging cereal in accordance with the present novel concept.

FIG. 29 is a flowchart schematically illustrating one exemplary embodiment of a method of packaging cereal in accordance with the present novel concept.

### DETAILED DESCRIPTION

The term “cereal,” as used herein is to be broadly interpreted to mean any ready-to-eat foodstuff in dry form that uses a grain from a cereal grass, such as wheat, oats, corn, barley or rice, for example, alone or in combination and in whole or refined form as its base product. This can include any known or future commercial cereal product in any natural or man-made shape or configuration. Examples of such ready-to-eat foodstuffs include, without limitation: whole grains; flakes of corn, wheat or oat; puffed corn or rice; and toasted or baked rice; coated or uncoated; and with or without other ingredients.

The term “rigid” as used herein is to be broadly interpreted to mean firm rather than pliant in composition or structure, and can include any construction, configuration and/or material. “Rigid” is intended to be a relative term contrasted with “flexible” or other similar terms. Thus, a “rigid” wall can be formed from a different material or combination of materials than a corresponding “flexible” wall. Alternately, a “rigid” wall could be formed from the same material as a corresponding “flexible” wall, but include a shape or one or more geometric features to increase the rigidity of the wall, such as an increased wall thickness or one or more stiffening ribs or other features, for example. Examples of “flexible” walls include common plastic bags, such as trash bags and freezer bags, for example, and plastic sheeting, such as may be used to cover an area or object, for example.

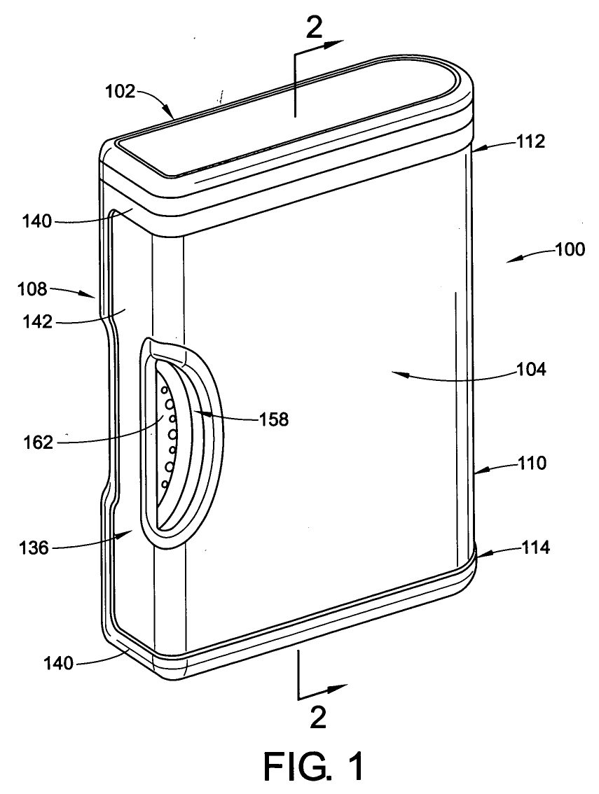

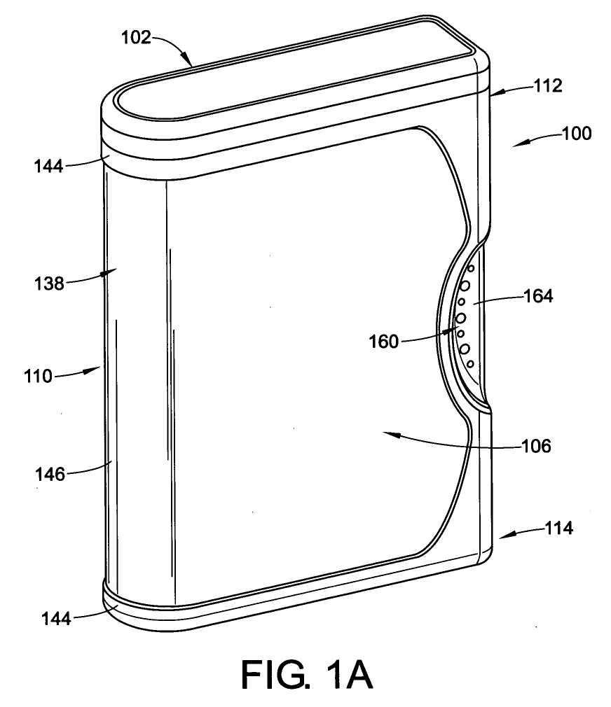

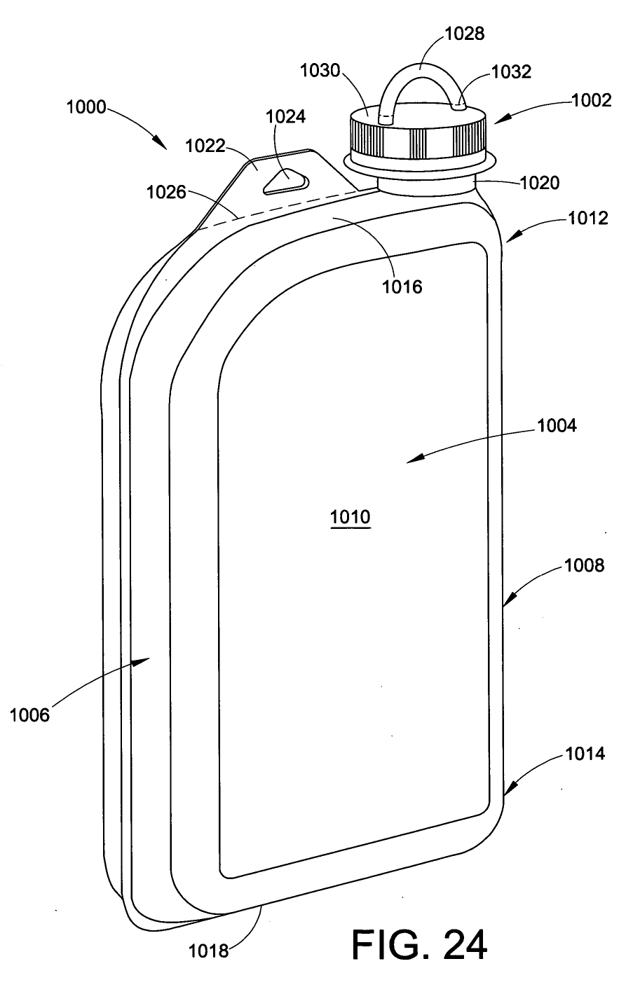

Turning now to the drawings, wherein the showings are for the purposes of illustrating exemplary embodiments of the present novel concept only, and not for limiting the same, FIGS. 1 and 1A illustrate a polymeric cereal container 100 and a polymeric container cap 102 supported thereon. Though it is to be distinctly understood that cereal containers in accordance with the present novel concept can be any size, shape or configuration, the exemplary embodiment of cereal container 100 includes a first side 104, an opposing second side 106, a first end 108 and an opposing second end 110. The sides and ends extend between a top 112 and a bottom 114 of the cereal container. It will be appreciated, however, that second side 106 and ends 108 and 110 are optional. A cereal chamber 116 (FIGS. 24) is at least partially defined by side 104, and optionally by one or more of side 106 and/or ends 108 or 110, if included. In the exemplary embodiment shown, cereal chamber 116 is defined between first side 104 and second side 106 extends between opposing ends 108 and 110, though it is to be understood that other alternate constructions could also be used.

As can be better seen in FIGS. 24, first side 104 of cereal container 100 includes a first side wall 118 having a first or outer wall portion 120 and an optional second or innerwall portion 122 projecting toward chamber 116. Similarly, second side 106 includes a second side wall 124 having a first or outer wall portion 126 and an optional second or inner wall portion 128 projecting toward chamber 116. Additionally, first side wall 118 and second side wall 124 respectively include first and second opening wall portions 130 and 132 that at least partially define a container opening 134 formed therebetween.

Returning again to FIGS. 1 and 1A, container ends 108 and 110 respectively include end walls 136 and 138. End wall 136 includes a first or outer wall portion 140 and an optional second or inner wall portion 142 projecting toward chamber 116. End wall 138 includes a first or outer wall portion 144 and an optional second or inner wall portion 146 projecting toward cereal chamber 116. In the present exemplary embodiment, end walls 136 and 138 differ in that end wall 136 is shown as being substantially planar whereas end wall 138 is curvilinear and is, thus, suitable for use as a pouring spout (not numbered).

As shown in FIGS. 24, end wall 138 includes an end opening wall portion 148 that at least partially defines container opening 134. End wall 136 similarly includes an end opening wall portion (not shown) generally opposite end opening wall 148 that also at least partially defines the container opening. In the present exemplary embodiment, the opening walls define the periphery of container opening 134, which generally terminates at a top wall 150 that extends along the opening wall portions. Additionally, an interlocking feature, such as a groove (not shown) or a projection 152, for example, extends along the periphery of the container opening either inwardly or outwardly of the opening wall portions.

Bottom 114 of cereal container 100 includes a bottom wall 154 that extend between the sides and ends of the container. Bottom wall 154 can be of any suitable shape or configuration, and is shown in the present exemplary embodiment as being substantially planar and having rounded corners 156 transitioning to the side and end walls. Additionally, a grip or handle feature can optionally be included along container 100 and can take any suitable size, shape and/or configuration. In the exemplary embodiment, recesses 158 and 160 are formed along end 108 and include recess walls 162 and 164 that extend into sides 104 and 106, respectively, and together function as a grip or handle feature. Though, it will be appreciated that any other suitable arrangement could alternately be used.

Container cap 102 is supported along top 112 of the cereal container and includes a first or closed end 166 and an opposing second or open end 168. The container cap includes an end wall 170 and a side wall 172 that extends peripherally along the end wall to respectively form the closed and open ends. An interlocking feature, such as a groove 174 or a projection (not shown), for example, is formed along side wall 172 and, in one exemplary embodiment, is adapted to engage the corresponding interlocking feature, such as projection 152, for example, on the opening wall portions of the cereal container. Thus, the container cap can be secured and retained on the container to repeatedly re-close the container and cereal chamber therein, and thereby prevent or minimize the ingress of moisture and substantially eliminate the entry of insects.

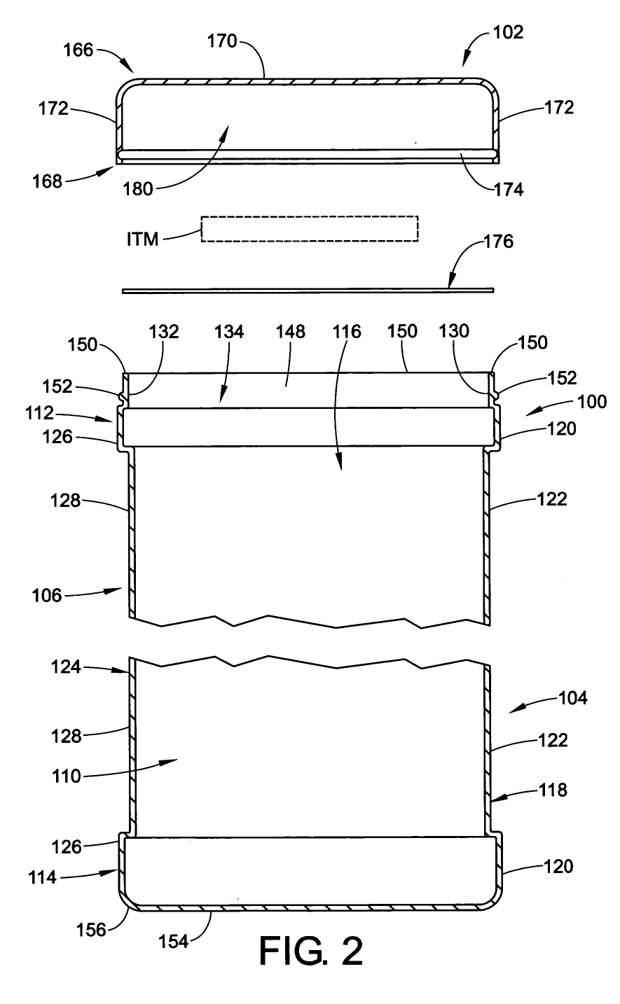

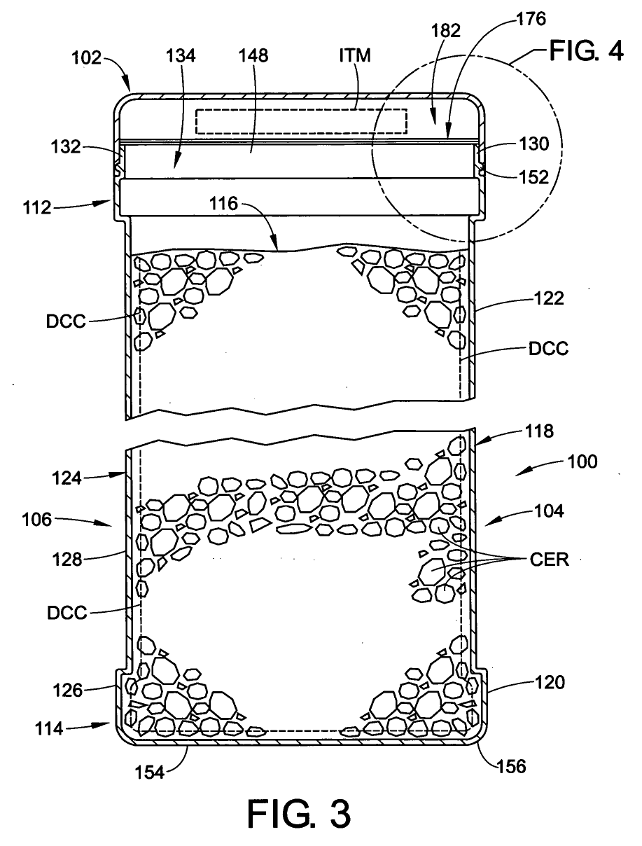

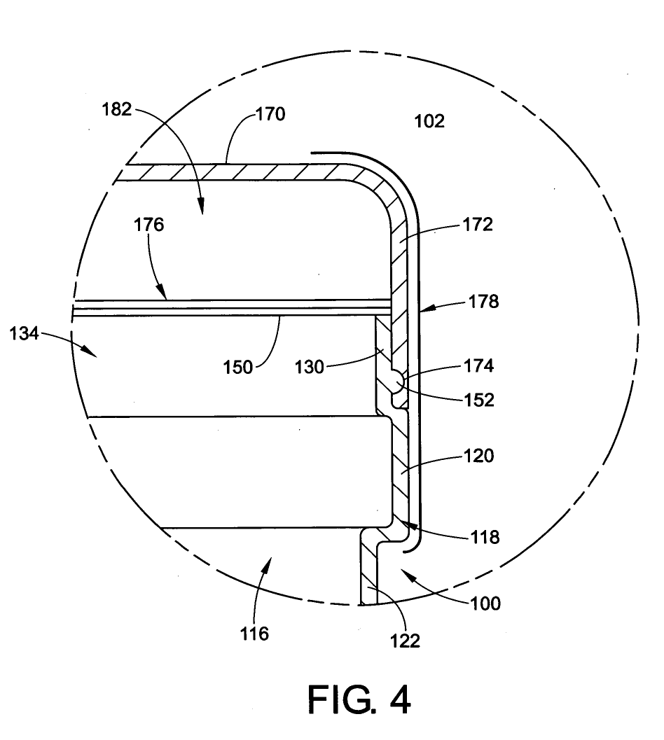

To prevent or minimize any inadvertent spillage of cereal product from the cereal container and to maintain freshness, a sealing member of any suitable type, kind or construction can be used to seal the cereal container. In the exemplary embodiment shown in FIGS. 2-4, a sealing member 176 is secured across container opening 134 along top wall 150 thereof to seal cereal product CER (FIG. 3) within cereal chamber 116. Sealing member 176 can be formed from any suitable material, such as a polymeric film, for example, and can be secured to the container in any suitable manner, such as by welding or using adhesive, for example. Additionally, sealing member 176 can optionally be of a tamper-evident construction. Alternately, or additionally, a sealing member 178 (FIG. 4) can be secured along side wall 172 of container cap 102. If included, sealing member 178 can engage both cereal container 100 and container cap 102 to prevent separation thereof and/or to make evident any attempt to cause such a separation. It will be appreciated that for the purposes of clarity sealing members 176 and 178 are shown in FIGS. 3 and 4 as being slightly spaced from the wall or walls with which the sealing members are associated.

FIG. 3 illustrates an assembled and sealed cereal container that is at least partially filled with cereal product CER. It will be appreciated that at least some of the quantity of cereal that is stored within the container will be in direct contact with cereal container 100 and the sides, ends and walls thereof, as is generally indicated by dashed line DCC. There are numerous advantages to this arrangement. For example, the use of a bag or other suitable liner formed from a plastic or coated paper material is entirely eliminated, reducing costs and packaging complexity. Thus, access to the cereal product is greatly improved due to the elimination of the crumpled bag. Additionally, the cereal product can be more easily dispensed from the container using the pouring spout, which in the present exemplary embodiment is formed by end wall 138.

As discussed above, container cap 102 includes a closed end 166 and an open end 168. Thus, the container cap and walls thereof define a cap cavity 180 (FIG. 2) that is accessible through open end 168. Once container cap 102 is installed on cereal container 100, cap cavity 180 can be used as a storage compartment 182 that is defined by the container cap and any other suitable wall, such as sealing member 176, for example. Storage compartment 182 can be used to receive and store any suitable promotional item or items, indicated generically by box ITM in FIGS. 2 and 3. As discussed above, promotional item ITM can be any suitable food or non-food item of any size, shape and/or configuration. Additionally, one of the numerous benefits to using such an arrangement is that the compartment is separate from the fully sealed cereal chamber. Thus, the issue of contamination due to the inclusion of the promotional item is avoided and the separate packaging or wrapping thereof may be eliminated. Furthermore, the storage compartment is formed separate and away from the cereal product using substantially rigid walls, as will be discussed in detail hereinafter. Thus, any design constraints that might otherwise be placed on the promotional item to prevent or minimize damage to the product or packaging (e.g., plastic bag and/or cardboard box) can be eliminated.

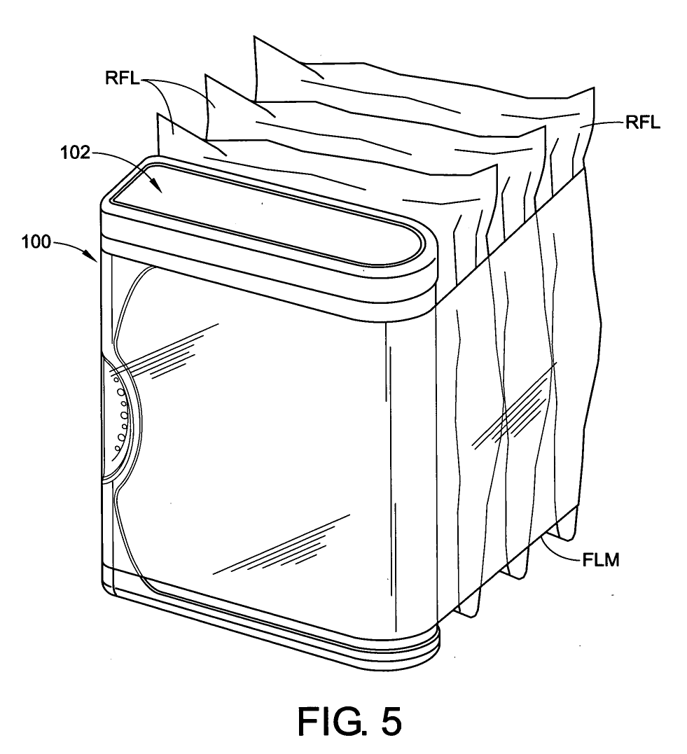

Cereal container 100 and container cap 102 can be marketed and sold together with one or more cereal product refills RFL in low-cost, bulk packaging. In the exemplary embodiment shown in FIG. 5, the container and cap are together with a plurality of product refills RFL using polymeric bags as the lower cost bulk packaging. The assembled container and cap along with the refills can be retained together in any suitable manner, such as by securing the same in a bundle with polymeric film FLM, for example. As discussed above, one of the advantages of the durable polymeric container is that the same can be repeatedly opened and closed without substantial degradation or damage to the container or cap. This permits the manufacturer to produce a highly identifiable (e.g., highly labeled and artistic) primary container that can be repeatedly used by the consumer as an in-the-cupboard or otherwise immediately accessible cereal container. Once the cereal initially provided in the container has been consumed, the consumer can re-fill the highly identifiable container using cereal product refills that are in lower cost packaging. That is, packaging that might be less highly decorated, non-reclosable and/or made from a less durable material, for example.

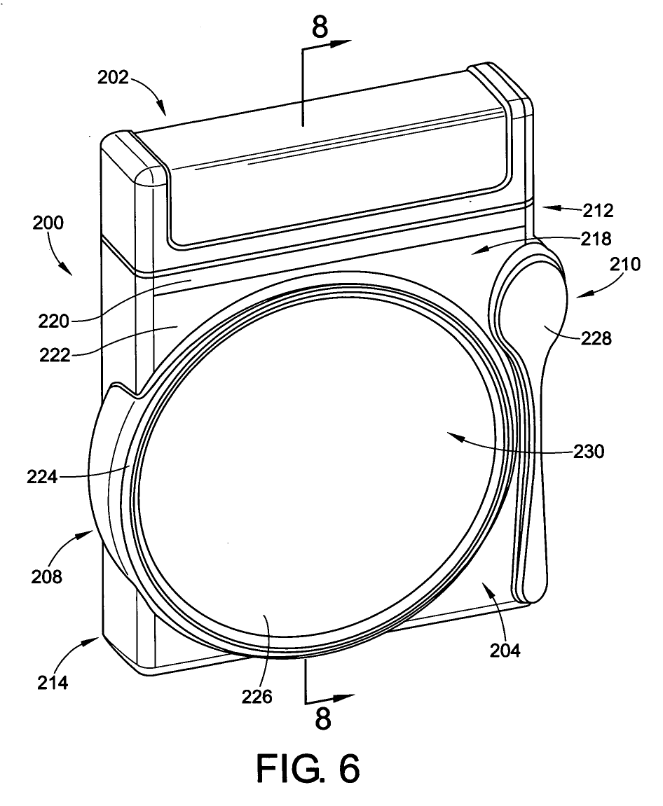

FIGS. 6-8 illustrate another exemplary embodiment of a polymeric cereal container 200 and a polymeric container cap 202. Cereal container 200 includes a first side 204, an optional opposing second side 206, an optional first end 208 and an optional opposing second end 210. The sides and ends extend between a top 212 and a bottom 214 of cereal container 200. A cereal chamber can be within container 200 by side 204 and optionally by side 206, if provided, and/or optionally by one or more of ends 208 or 210, if provided. In the present exemplary embodiment, cereal chamber 216 is shown as being formed between sides 204 and 206 extending between ends 208 and 210.

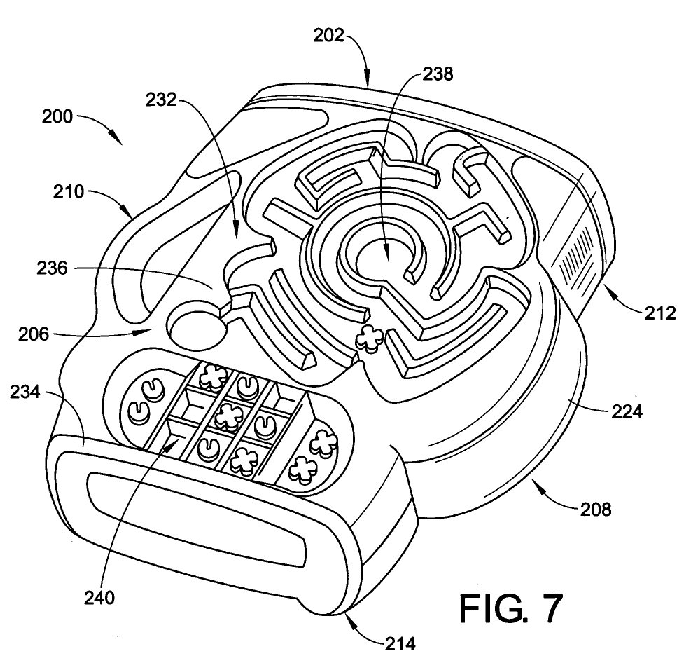

First side 204 of cereal container 200 includes a first side wall 218 that has a first or outer wall portion 220 and an optional second or inner wall portion 222. One or more contoured surfaces can be formed along one or more of wall portions 220 and/or 222. In the present exemplary embodiment, second or innerwall portion 222 includes a first contoured portion 224 that projects outwardly from cereal chamber 216 and a second contoured portion 226 that projects inwardly toward cereal chamber 216 from along first contoured portion 224. Additionally, a third contoured portion 228 is formed adjacent the first and second contoured portions. It will be appreciated that the inner and outer wall portions as well as any contoured portions thereof can take any suitable shape, form or configuration. For example, outer wall portion 220 is shown as being substantially planar and second contoured portion 226 is shown as being bowl shaped and forming a cavity 230 extending inwardly toward cereal chamber 216. Furthermore, third contoured portion 228 is shown as being shaped as a spoon. As can be seen in FIGS. 6 and 7, parts of the various contoured portions extend beyond first side 204 and along ends 208 and 210. Thus, the ends can optionally include contoured and/or planar portions.

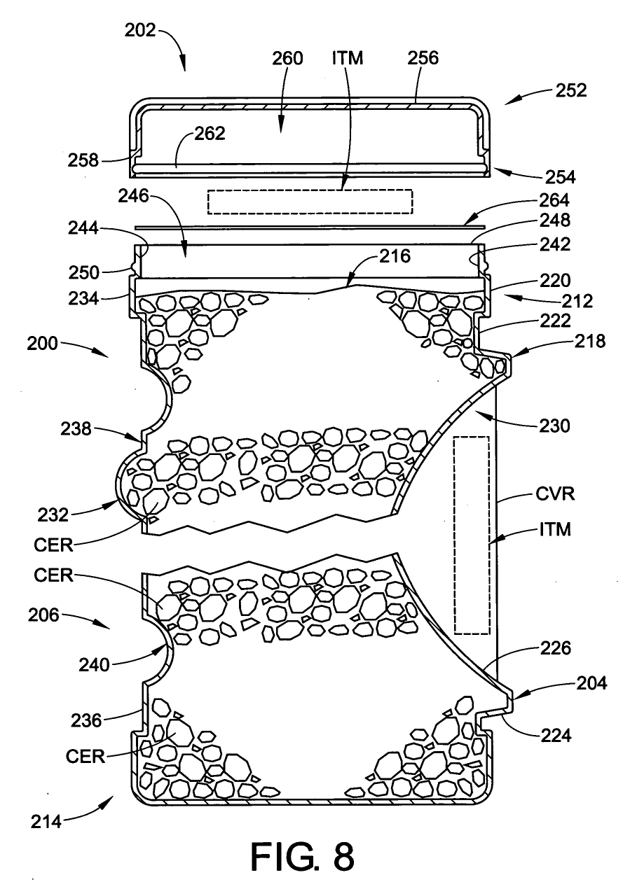

Second side 206 includes a second side wall 232 that has a first or outer wall portion 234 and an optional second or inner wall portion 236. As with first side 204, second side 206 can include one or more contoured portions along either or both of wall portions 234 and/or 236. In the present exemplary embodiment, inner wall portion 236 includes two separate contoured portions 238 and 240, which can take any suitable shape, form or configuration. As shown in FIGS. 7 and 8, contoured portions 238 and 240 are formed as activity panels having a plurality of inwardly and outwardly projecting areas (not numbered). It is to be understood that the activity panels can be of any suitable size, shape and/or configuration of games, such as a maze and a tic-tac-toe game, for example, or other activities and that those activity panels shown are merely illustrative of exemplary panels. Further, it is to be distinctly understood that any number and/or any type of features or panels can be included, for either children or adults, without departing from the principles of the present novel concept.

Side walls 218 and 232 respectively include opening wall portions 242 and 244 that at least partially define a container opening 246 in communication with cereal chamber 216. Additionally, ends 208 and 210 include end walls (not numbered) that have end opening wall portions (not numbered) extending between opening wall portions 242 and 244 and forming a periphery about container opening 246. The opening wall portions include a top wall 248 and an interlocking feature, such as a groove (not shown) or a projection 250, for example.

Container cap 202 includes a first or closed end 252 and a second or open end 254. The container cap also includes an end wall 256 and a side wall 258 disposed along end wall 256 and extending therefrom to form a cap cavity 260 accessible from open end 254. A suitable interlocking feature, such as a groove 262 or a projection (not shown), for example, is disposed along side wall 258 for engaging a corresponding interlocking feature, such as projection 250, for example. It will be appreciated, however, that any other suitable feature or combination of features can alternately be used, and that the interlocking features shown and described are merely exemplary.

One or more sealing members can be used to secure a cereal product CER in the cereal compartment of container 200, as discussed above with regard to cereal container 100, prior to installation of container cap 202. For example, a sealing member 264 can be secured along top wall 248 to seal the cereal product within the cereal chamber. Additionally, or in the alternative, an exterior sealing member (not shown) can be used. Once container cap 202 is installed on the container, cap cavity 260 can be used as a storage compartment (not numbered) in conjunction with a suitable wall, such as sealing member 264, for example. The storage compartment can receive and store any suitable size or type of promotional item or items, including food or non-food items, and is indicated generally by rectangular box ITM. Additionally, or in the alternative, cavity 230 can be used to store one or more items ITM, and a label or other suitable cover CVR can be used to secure these items in the cavity and/or hide from view the contents thereof.

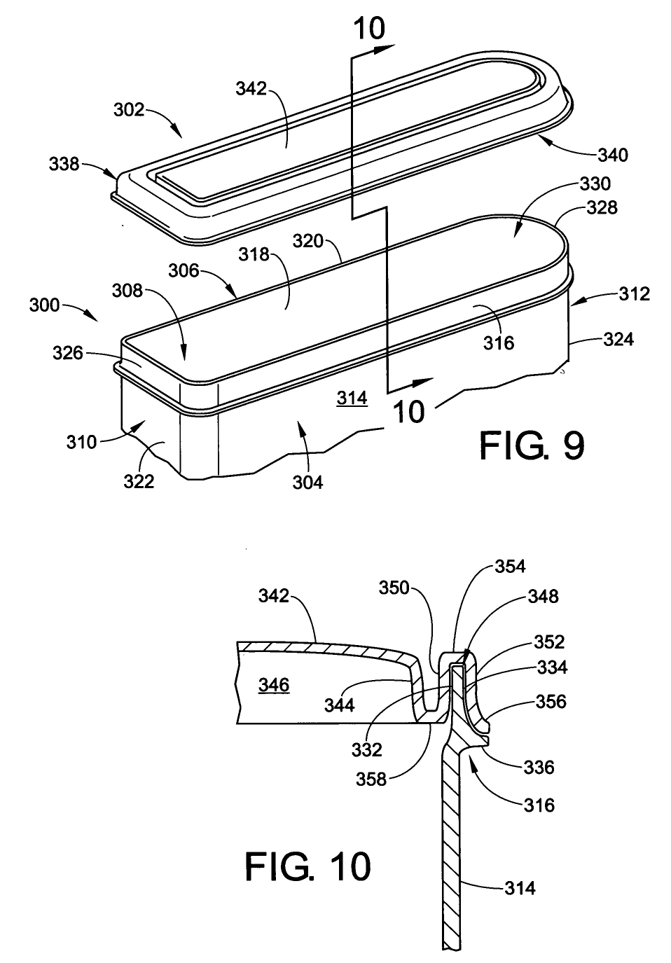

FIGS. 9 and 10 illustrate a polymeric cereal container 300 and a polymeric container cap 302. Generally, cereal container 300 is similar polymeric cereal containers 100 and 200, in that cereal container 300 includes a first side 304 and an optional opposing second side 306 that at least partially define a cereal chamber 308 therebetween. Additionally, container 300 can optionally include a first container end 310 extending between the first and second sides, and an optional second container end 312 opposite first end 310. It will be appreciated that sides 304 and 306, and ends 310 and 312 can be of any suitable shape, form, configuration or construction, such as has been described in detail above with regard to containers 100 and 200, for example.

First side 304 includes a first side wall 314 having a first opening wall portion 316, and second side 306 includes a second side wall 318 having a second opening wall portion 320. Similarly, ends 310 and 312, if provided, include end walls 322 and 324 respectively having opening wall portions 326 and 328. Opening wall portions 316, 320,326 and 328 extend peripherally around a container opening 330 formed in the container and generally define the same.

As can be better seen in FIG. 10, the opening wall portions include an inner opening surface 332 and an outer opening surface 334. In the exemplary embodiment shown, inner opening surface 332 is offset outwardly from the side wall, such as first side wall 314, for example, and outer opening surface 334 is similarly offset outwardly from the side wall. Optionally, either one or both of opening surfaces 332 and 334 can be angled relative to one another to form a tapered opening wall portion. The angle or taper (not numbered) between the surfaces can be of any suitable amount, such as may be useful for sealing or mold release purposes, for example. Additionally, an optional projection or ridge 336 extends outwardly from outer opening surface 334.

Polymeric container cap 302 is adapted to be received on polymeric cereal container 300 along the opening wall portions forming container opening 330. Container cap 302 includes a first or closed end 338 and an opposing second or open end 340. Closed end 338 includes a cap end wall 342. A cap side wall 344 extends from the cap end wall and peripherally along the same to form open end 340 and at least partially define a cap recess 346.

As discussed above, it is desirable for the polymeric cereal container and polymeric container cap to include complimentary interlocking features suitable for securing the container cap on the cereal container. In the present exemplary embodiment, opening wall portions 316, 320, 326 and 328 are collectively operative as a first interlocking feature. A complimentary second interlocking feature is formed on container cap 302 and in the present exemplary embodiment includes a groove or channel 348 adapted to receive the opening wall portions and form an interlocking fit or seal with the same. Channel 348 is formed between an inner channel wall 350 and an outer channel wall 352 that are joined at a closed end of the channel by a channel end wall 354. It will be appreciated that channel 348 and walls 350, 352 and 354 can take any suitable form, shape and/or configuration. In the exemplary embodiment shown in FIGS. 9 and 10, inner and outer channel walls 350 and 352 are shown as being angled relative to one another to form a tapered channel. It will be appreciated, however, that the optional angle of the inner and outer channel walls can be of any suitable amount, and in one exemplary embodiment is complimentary to a taper on or along the opening wall portions. Outer channel wall 352 includes an outwardly flared lip 356 to assist the consumer in opening the lid. Additionally, a connector wall 358 extends between inner channel wall 350 and cap side wall 344 to connect the interengaging feature along open end 340.

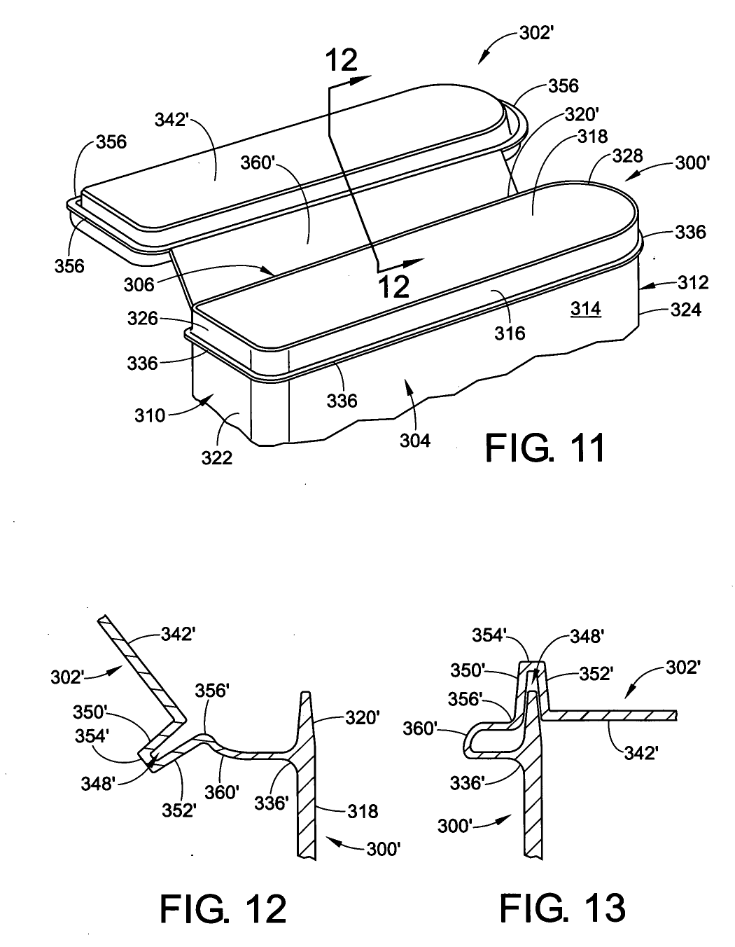

FIGS. 11-13 show a polymeric cereal container 300′ and a polymeric container cap 302′. It will be appreciated that container 300′ and cap 302′ are substantially similar to polymeric cereal container 300 and polymeric container cap 302 discussed above in detail with regard to FIGS. 9 and 10. Thus, like items and/or features will be shown and described using like item numbers, and new or modified items and/or features will be shown and described using primed (′) item numbers.

Polymeric cereal container 300′ and polymeric container cap 302′ differ from the container and cap described above with regard to FIGS. 9 and 10 in that container 300′ and cap 302′ are interconnected with one another by a hinge wall 360′ that is preferably integrally formed between the polymeric container and the polymeric cap. Thus, container 300′ and cap 302′ are preferably integrally formed with one another. Whereas, container 300 and cap 302 in FIGS. 9 and 10 can be formed separately, and even using different manufacturing processes and/or different materials or grades of material.

In the exemplary embodiment shown, polymeric cereal container 300′ includes first and second sides 304 and 306, which include container side walls 314 and 318, respectively, as described above. Additionally, ends 310 and 312 include end walls 322 and 324, respectively, as described above. Side wall 314 and end walls 322 and 324 respectively include opening wall portions 316, 326 and 328, as discussed above. Side wall 318, however, includes an opening wall portion 320′ that differs slightly from opening wall portion 320 described above. Optional projection or ridge 336 extends along opening wall portions 316, 326 and 328 of cereal container 300′. However, ridge 336′ is shown extending along opening wall portion 320′ of the cereal container. Similarly, optional lip 356 extends along the portions of cap 302′ corresponding to opening wall portions 316, 326 and 328 of container 300′. However, optional lip 356′ is shown extending along the portions of cap 302′ corresponding to opening wall portion 320′. In the exemplary embodiment shown, hinge wall 360′ extends between ridge 336′ and lip 356′ and forms a living hinge securing polymeric container cap 302′ to polymeric cereal container 300′.

Additionally, polymeric container cap 302′ differs from cap 302 in FIGS. 9 and 10 in that cap 302′ includes a groove or channel 348′ and corresponding channel walls 350′, 352′ and 354′ that are connected directly to an end wall 342′ of the cap. Thus, cap 302′ does not include a cap side wall 344 as shown in and described with regard to cap 302 in FIGS. 9 and 10. Furthermore, without cap side wall, cap recess 346 of cap 302 is not formed in cap 302′. It will be appreciated, however, that a suitable side wall could alternately be included in cap 302′ to form the optional recess.

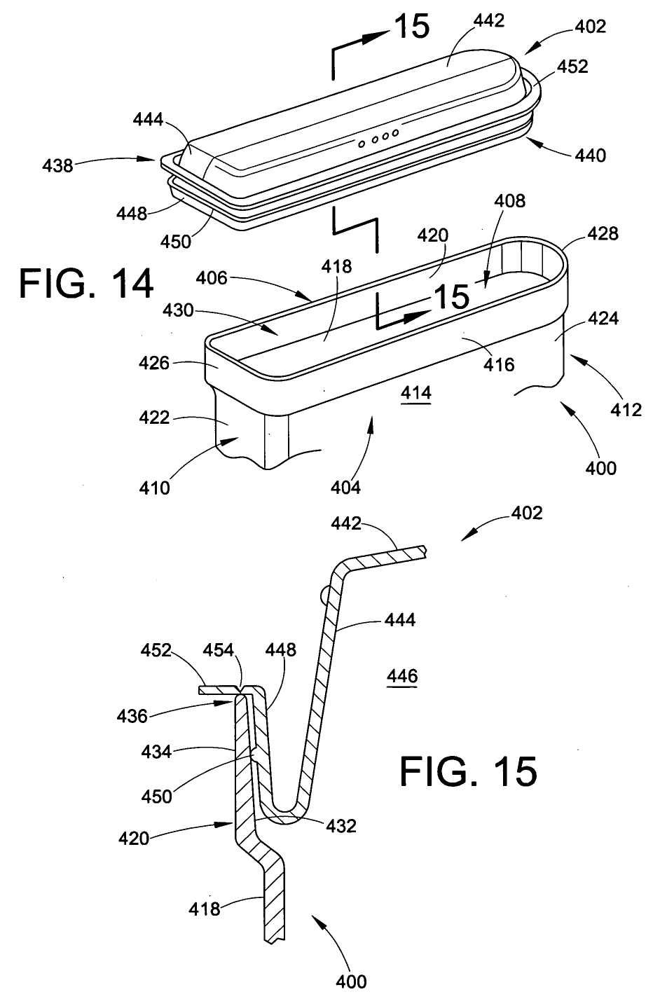

FIGS. 14 and 15 illustrate a polymeric cereal container 400 and a polymeric container cap 402. Generally, cereal container 400 is similar to polymeric cereal containers 100, 200 and 300, in that cereal container 400 includes a first side 404 and an optional opposing second side 406 that at least partially define a cereal chamber 408. Additionally, container 400 can optionally include a first container end 410 extending between the first and second sides, and an optional second container end 412 opposite first end 410. It will be appreciated that sides 404 and 406, and ends 410 and 412 can be of any suitable shape, form or construction, such as has been described in detail above with regard to containers 100, 200 and 300, for example.

First side 404 includes a first side wall 414 having a first opening wall portion 416, and second side 406 includes a second side wall 418 having a second opening wall portion 420. Similarly, ends 410 and 412, if provided, include end walls 422 and 424 respectively having opening wall portions 426 and 428. Opening wall portions 416, 420, 426 and 428 extend peripherally around a container opening 430 formed in the container and generally define the same. Though it will be appreciated that the opening wall portions can take any suitable form, shape and/or configuration, in the exemplary embodiment shown in FIGS. 14 and 15 opening wall portions 416, 420, 426 and 428 are offset outwardly from the corresponding side or end wall. Additionally, opening wall portions 416, 420, 426 and 428 include an inner opening surface 432, an outer opening surface 434 and a wall portion end 436. Optionally, either one or both of the opening surfaces can be angled to at least partially taper the opening wall portions.

Polymeric container cap 402 includes a first or closed end 438 and a second or open end 440. Closed end 438 includes an cap end wall 442. A cap side wall 444 extends from cap end wall 442 toward open end 440 and at least partially defines a cap recess 446 within cap 402. An outer interengaging wall 448 extends from cap side wall 444 and is suitable for being received within container opening 430 along opening wall portions 416, 420, 426 and 428. Outer interengaging wall 448 can optionally include one or more interlocking features, such as a rib 450 extending along the interengaging wall, for example. If included, any interlocking features can engage opening wall portions 416, 420, 426 and 428 to secure or assist in securing cap 402 on container 400. In the exemplary embodiment shown, rib 450 extends along at least a portion of interengaging wall 448 and is in abutting engagement with inner opening surface 432 to form an interference fit with the opening wall portions.

Additionally, an outwardly extending peripheral flange or lip 452 extends around cap 402 along wall 448. Lip 452 provides a positive stop for cap 402 to be received within container opening 430. Furthermore, lip 452 can be heat staked, welded, thermoformed or otherwise secured to wall portion end 436 to secure the cap on the container. A tear-groove 454 or other suitable feature can be provided or formed along lip 452. The tear-groove is preferably operable to unseal and detach the cap and the container. However, it will be appreciated that sealing members, such as sealing members 176, 178 and/or 264 shown and described hereinbefore, for example, can alternately or additionally be used.

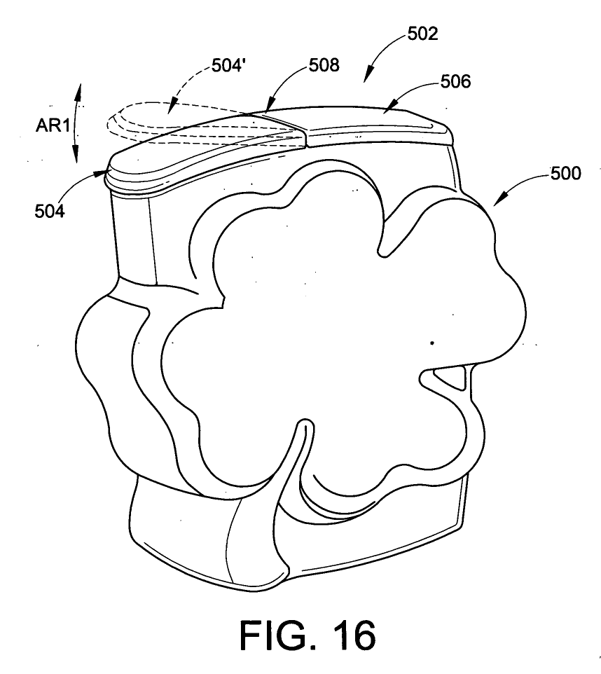

FIG. 16 shows a polymeric cereal container 500 and a polymeric container cap 502 secured on the polymeric cereal container. It will be appreciated that cereal container 500 can be of any suitable size, shape, form and/or configuration, such as has been described with regard to exemplary polymeric cereal containers 100, 200, 300 and 400 shown in earlier drawing figures, for example. As such, a full detailed description of the container is not provided.

Container cap 502, however, differs from earlier described caps, such as polymeric container caps 102, 202, 302 and 402, for example, in that container cap 502 includes cap sections 504 and 506 that are, in one preferred embodiment, independently securable on container 500. A hinge 508 is formed between the two cap sections, and can take any suitable shape, form or configuration. In the exemplary embodiment shown, hinge 508 is integrally formed between sections 504 and 506 as a living hinge. Preferably, hinge 508 will permit one of the cap sections, such as cap section 504, for example, to be dislodged or otherwise separated from on or along container 500, as indicated by cap section 504′ shown in dashed lines and arrow AR1, for example, to provide access to the cereal chamber (not shown) of the polymeric cereal container.

Container cap 502 can be secured on cereal container 500 in any suitable manner. For example, one or more sealing members, such as sealing members 176, 178 and/or 264, for example, can be used to initially secure the cap on the container. Thereafter one or more of the interlocking features or other suitable arrangements can be used to maintain the closure of the cap. As another example, a tear seal, such as that shown in and described with regard to FIGS. 14 and 15, for example, could extend fully or partially around the cap. By tearing the seal as discussed above, the section and/or hinge can be released from being secured on the container, and permit movement of the section to open and close the same on the container.

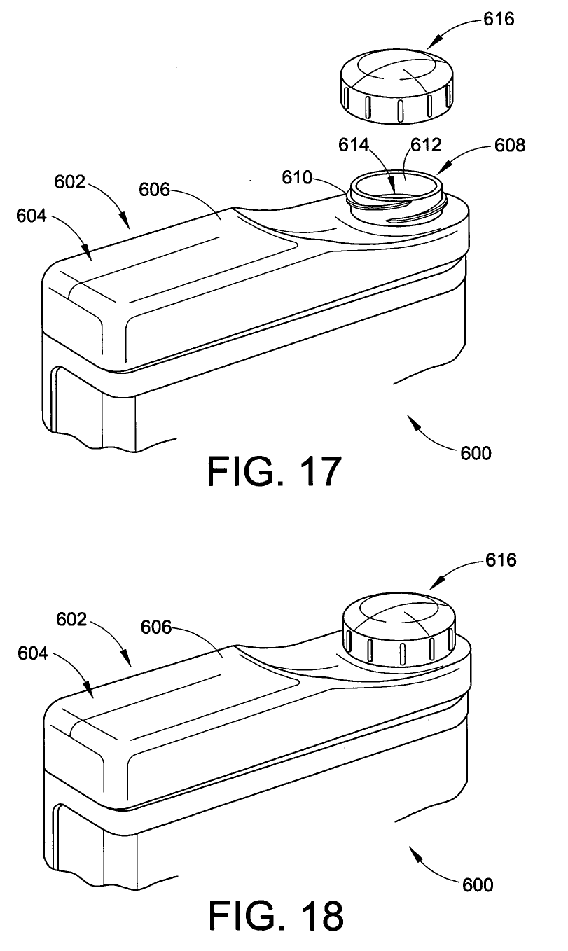

FIGS. 17 and 18 show a polymeric cereal container 600 and a polymeric container cap 602 secured on the polymeric cereal container. It will be appreciated that cereal container 600 can be of any suitable size, shape, form and/or configuration, such as has been described with regard to exemplary polymeric cereal containers 100, 200, 300, 400 and 500 shown in earlier drawing figures, for example. As such, a full detailed description of the container is not provided.

Container cap 602, however, differs from earlier described caps, such as polymeric container caps 102, 202, 302,402 and 502, for example, in that container cap 602 includes cap body 604 that includes an end wall 606 and a projection or boss 608 extending from end wall 606. Boss 608 includes one or more interlocking or interengaging features, such as threads 610, for example, formed along an outside wall (not numbered) thereof. Boss 608 also includes an inside wall 61-2 extending through end wall 606 and forming a passage 614 providing access to the cereal chamber (not shown) within the polymeric cereal container. Boss 608 and passage 614 are suitable for operation as a pouring spout to pour cereal product out of the cereal container. A passage cap 616 includes one or more complimentary interlocking or interengaging features, such as complimentary threads (not shown), for example, and is suitable for threadably engaging boss 608 to close passage 614.

For manufacturing, filling and/or other reasons, container cap 602 is preferably removable from cereal container 600 in a conventional manner, such as has been described herein with regard to earlier embodiments, for example. As such, a suitable sealing member, such as sealing member 176,178 and/or 264, for example, can be used to secure the container cap on the container. Alternately, or additionally, a tear seal or other suitable arrangement could be used on the container cap and/or the passage cap.

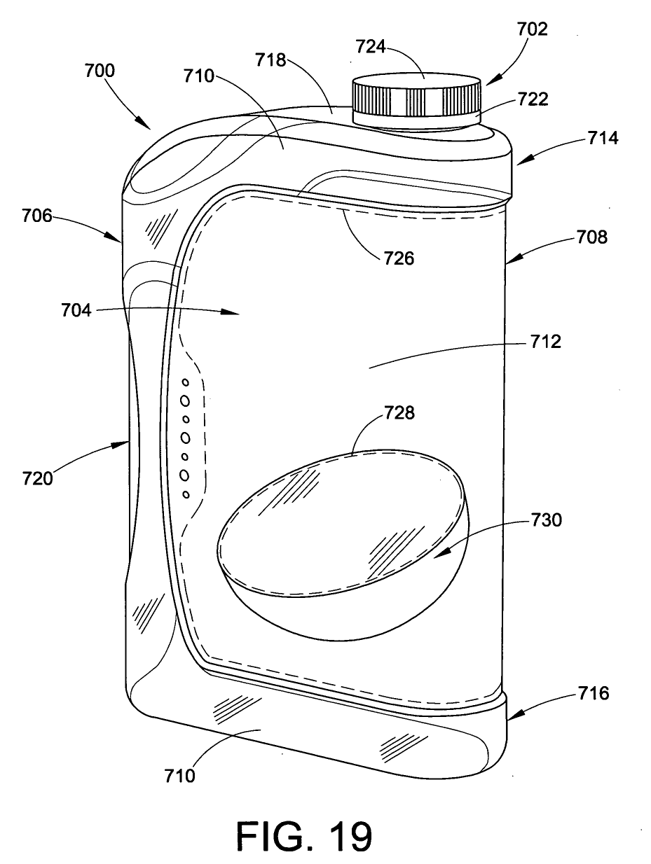

FIG. 19 illustrates a polymeric cereal container 700 and a polymeric container cap 702 secured on the polymeric cereal container. It will be appreciated that cereal container 700 can be of any suitable size, shape, form and/or configuration, such as has been described with regard to exemplary polymeric cereal containers 100, 200, 300, 400, 500 and/or 600 shown in earlier drawing figures, for example. Polymeric cereal container 700 includes a first side 704, an optional second side (not numbered), and optional first and second ends 706 and 708. In the embodiment shown, the first and second sides are approximately planar and include optional first and second side walls 710 and 712. The first side, optional second side, and optional first and second ends extend between a top 714 and a bottom 716 of container 700. Container 700 includes a top wall 718 disposed along top 714 and a bottom wall (not shown) disposed along bottom 716. An optional grip or handle feature 720 is shown as being disposed along first end 706. Cap 702 can be secured on polymeric cereal container 700 in any suitable manner, such as by using complimentary interengaging or interlocking features (not shown), for example.

Container 700 and cap 702 differ from other embodiments, such as container 600 and cap 602 in FIGS. 17 and 18, for example, in that top wall 718 is integrally formed on container 700 rather than being part of a polymeric container cap, such as cap 602, for example. As such, one or more interengaging or interlocking features can be formed on or along the top wall, such as a plurality of threads (not shown) formed along a projection or boss (not shown) extending from the top wall, for example. Container cap 702 can then include one or more complimentary interengaging or interlocking features, such as a plurality of threads (not shown), for example, formed along a side wall 722 that extends from a top wall 724 of the container cap. In one preferred embodiment, container cap 702 will cover a passage (not shown) or other suitable feature formed through the top wall, such as through or along a projection or boss (not shown), for example, and be suitably dimensioned for dispensing a cereal product therefrom and also for refilling the container with polymeric cereal, such as from a bulk packaging refill, for example.

Container 700 also differs from other embodiments illustrated and/or described herein in that the container is shown as being formed from an at least partially transparent or translucent polymeric material, such that a feature or characteristic (e.g., color, shape, size, composition, container fill level) of any cereal product stored within the container chamber (not shown) thereof can be at least partially observed, determined or otherwise distinguished through the container sides, ends or other portions. Additionally, it will be appreciated that any of the other polymeric cereal container embodiments disclosed herein could optionally include one or more parts, areas, walls and/or other portions formed from such an at least partially transparent and/or translucent material.

In one embodiment, an opaque wall portion 726 is provided along the polymeric cereal container, and is suitable for including text and graphics of various sorts, such as to identify the cereal and the manufacturer, to provide nutritional and other information, to provide market-appropriate information, promotional materials and/or other marketing items, such as games and activities for children, for example. Opaque wall portion 726 can be formed on or along the sides, ends and/or walls of the polymeric cereal container in any suitable manner. For example, opaque wall portion 726 could be formed from colored polymeric material formed into the sides, ends, and/or walls. As another example, opaque wall portion 726 could be formed from a colored polymeric material disposed on or along the sides, ends and/or walls, such as a polymeric label or over-molded layer, for example. As still another example, opaque wall portion 726 could be formed from an ink or other colorant applied on or along the sides, ends and/or walls. Additionally, opaque wall portion 726 can be of any suitable size, shape, configuration and/or arrangement, and can include text, markings and/or indicia of any type or kind and in any suitable configuration. For example, in the exemplary embodiment shown in FIG. 19, opaque wall portion 726 includes a representation of a bowl 728 with an opening 730 formed within the opaque wall portion to permit the cereal product within the polymeric cereal container to be viewed through the at least partially transparent or translucent wall, as if the cereal was in the bowl. It will be appreciated, however, that the foregoing discussion is merely exemplary and that any other configuration, arrangement and/or representation could alternate, or additionally, be used.

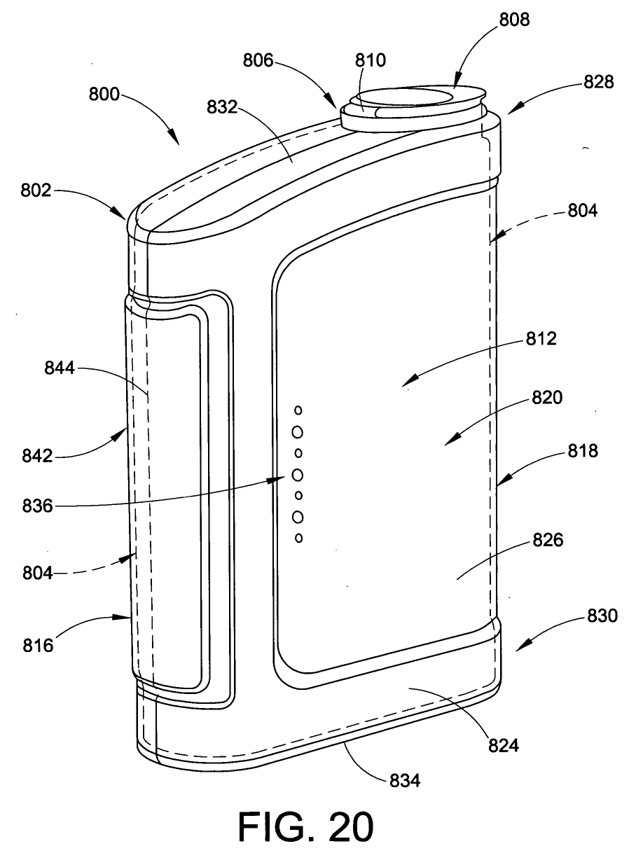

FIG. 20 illustrates another embodiment of a polymeric cereal container 800 that includes an outer container portion 802 and an inner container portion 804. In the embodiment shown in FIG. 20, a top or upper part (not numbered in FIG. 20) of the inner container portion extends outwardly from outer container portion 802 and is adapted to provide access, such as through an opening or passage 806 formed therethrough, for example, to a cereal chamber (not shown) formed within the inner container portion. A polymeric container cap 808 is received on the top or upper part of the inner container portion and can be secured thereto in any suitable manner, such as by complimentary interengaging features (e.g., a snap-fit walls or a plurality of interengaging threads), for example. Additionally, a strap 810 can optionally be secured on or along one of the inner or outer container portions, for example.

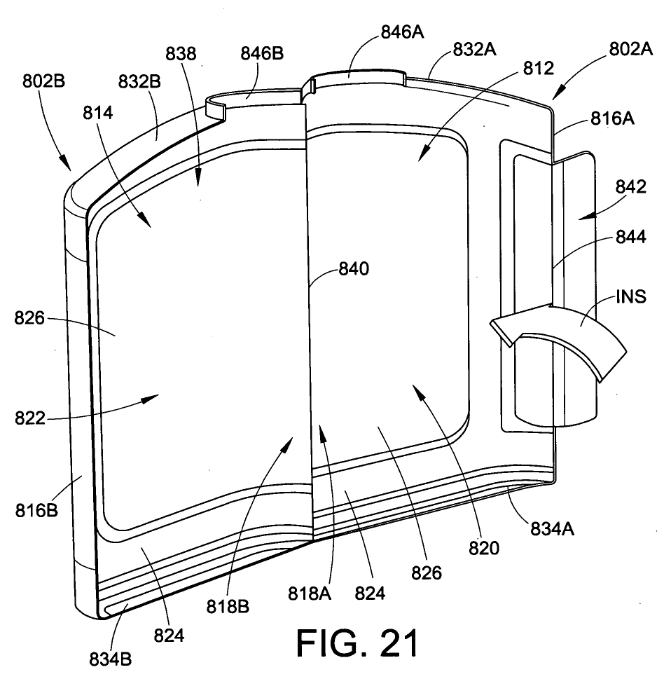

Outer container portion 802 can be of any suitable size, shape and/or configuration, and can include any suitable geometric features, other characteristics or any combination thereof. In the exemplary embodiment shown in FIGS. 20 and 21, outer container portion 802 includes a first side 812, an optional second side 814, and optional first and second ends 816 and 818. First and second sides 812 and 814 are shown in the present exemplary embodiment as respectively including first and second side walls 820 and 822. The first and second side walls are each shown as including a first or outer wall portion 824 and a second or inner wall portion 826. Additionally, outer container portion 802 includes a top 828 and a bottom 830 that respectively include a top wall 832 and a bottom wall 834. The first side as well as the optional second side and the optional first and second ends extend between the top and bottom of outer container portion 802. A suitable grip or handle feature 836 can be optionally provided on or along the outer container portion, such as along sides 812 and 814, for example.

As can be better seen in FIG. 21, outer container portion 802 is at least partially formed as two sections 802A and 802B, which can be separated or otherwise disassociated from one another in any suitable manner to provide access to an outer container cavity 838 formed therein that is adapted for receiving inner container portion 804. It will be appreciated that the two sections of the outer container portion can be connected or otherwise secured together in any suitable manner. For example, second end 818 can be formed into two second end sections 818A and 818B that are joined by an integrally formed hinge 840 or other suitable feature and/or arrangement. Thus, as the two sections of the outer container portion are brought together, two top wall sections 832A and 832B as well as two bottom wall sections 834A and 834B are brought together to respectively form top wall 832 and bottom wall 834. Additionally, as the two sections of the outer container portion are brought together, two first end sections 816A and 816B are similarly brought together to form first end 816. Optionally, one or more of the end sections and/or wall sections can include one or more interengaging features (not shown), such as complimentary clips or overlapping wall portions, for example, suitable for at least partially securing and/or reinforcing the corresponding end sections and/or wall sections to one another.

Furthermore, sections 802A and 802B of the outer container portion can be secured together in any suitable manner. For example, a securement member, such as a securement clip 842, for example, can be flexed or pivoted along a suitable feature or component, such as an integrally formed hinge 844, for example, to selectively engage a corresponding feature or component (not shown) on the opposing section of the outer container portion, such as section 802B, for example.

In use, the two opposing sections are opened, such as in the manner shown in FIG. 21, for example. The inner container portion can then be inserted into the outer container cavity, as indicated by arrow INS. Sections 802A and 802B can then be closed to capture the inner container portion with only a top or upper part thereof extending outwardly through passage 806, which can be formed through top wall 832 by passage walls 846A and 846B. The engagement member can then be secured to the opposing section of the outer container portion to maintain the opposing sections in a closed relationship.

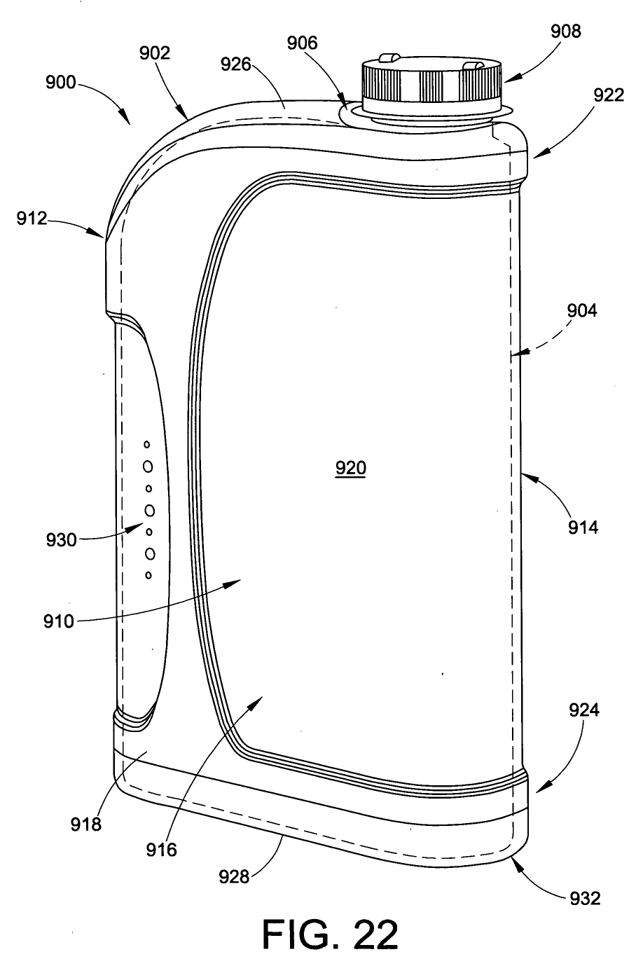

FIG. 22 illustrates another embodiment of a polymeric cereal container 900 that includes an outer container portion 902 and an inner container portion 904. In the embodiment shown in FIG. 22, a top or upper part (not numbered in FIG. 22) of the inner container portion extends outwardly from outer container portion 902 and is adapted to provide access, such as through an opening 906 formed therethrough, for example, to a cereal chamber (not shown) formed within the inner container portion. A polymeric container cap 908 is received on the top or upper part of the inner container portion and can be secured thereto in any suitable manner, such as by using complimentary interengaging features (e.g., a plurality of interengaging threads), for example.

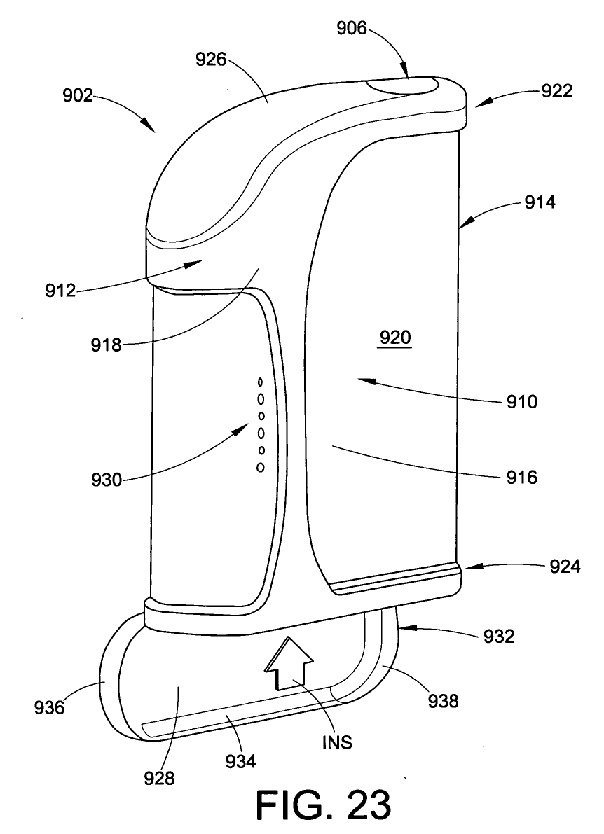

Outer container portion 902 can be of any suitable size, shape and/or configuration, and can include any suitable geometric features, other characteristics or any combination thereof. In the exemplary embodiment shown in FIGS. 22 and 23, outer container portion 902 includes a first side 910, an optional second side (not shown), and optional first and second ends 912 and 914. In the present embodiment, the first and second sides respectively include a first side wall 916 and a second side wall (not shown). The first side wall is shown as including a first or outer wall portion 918 and a second or inner wall portion 920. The second side wall can optionally include similar wall portions (not shown). Additionally, outer container portion 902 includes a top 922 and a bottom 924 that respectively include a top wall 926 and a bottom wall 928. The first side as well as the optional second side and the optional first and second ends extend between the top and bottom of outer container portion 902. A suitable grip or handle feature 930 can be optionally provided on or along the outer container portion, such as along the first and second sides, for example.

Outer container portion 902 differs from outer container portion 802 shown in and discussed with regard to FIGS. 20 and 21 in that outer container portion 902 does not include a split or clamshell-type arrangement. Rather, outer container portion 902 includes a separable cover or bottom portion 932 formed along bottom 924 that provides access to an outer container cavity (not shown), as shown in FIG. 23. In the exemplary embodiment shown, bottom portion 932 includes bottom wall 928 and one or more bottom edge walls, such as edge walls 934, 936 and 938 can optionally extend from bottom wall 928. Additionally, an edge wall (not shown) can be disposed opposite edge wall 934. In one exemplary embodiment, bottom portion 932 can be fully separated from the outer container portion and suitable interengaging features can optionally be provided along the edge walls and/or the sides and ends of the outer container portion for retaining the bottom portion thereon. Alternately, or additionally, a suitable retaining wall (not shown), such as hinge wall 360′ in FIGS. 11-13, for example, could be provided and extend between an edge wall and the outer container portion in a suitable manner.

In use, bottom portion 932 is separated or otherwise disassociated with the remainder of outer container portion 902, such as is shown in FIG. 23, for example. The inner container portion can then be inserted into the outer container cavity, as indicated by arrow INS. The inner container portion is received within the outer container cavity a sufficient distance such that the top or upper part of the inner container portion extends through opening 906 as indicated in FIG. 22. Thereafter, the outer container portion can be closed in a suitable manner, such as by bottom portion 932 being operatively connected on the outer container portion.

One exemplary embodiment of a polymeric cereal container 1000 that is suitable for use as an inner container portion, such as inner container portion 804 or 904, for example, is shown in FIG. 24. A polymeric container cap 1002 is disposed on polymeric cereal container 1000 and can be secured thereon in any suitable manner, such as by using a plurality of interengaging threads (not shown) or other features, for example. It will be appreciated that cereal container 1000 can be of any suitable size, shape, form and/or configuration, such as has been described with regard to exemplary polymeric cereal containers 100, 200, 300, 400, 500 and/or 600 shown in earlier drawing figures, for example.

Polymeric cereal container 1000 includes a first side 1004, an optional second side (not shown), and optional first and second ends 1006 and 1008. In the embodiment shown, the first side is approximately planar and includes a first side wall 1010. The second side, if provided, can be of a similar configuration or can alternately include additional features. The first side, optional second side, and optional first and second ends extend between a top 1012 and a bottom 1014 of container 1000. Container 1000 includes a top wall 1016 disposed along top 1012 and a bottom wall 1018 disposed along bottom 1014.

Polymeric cereal container 1000 includes a cereal cavity (not shown) formed by first side 1004 as well as by any optional sides and/or ends, such as the second side (not shown) and first and second ends 1006 and 1008, for example. A passage wall 1020 extends from top wall 1016 and at least partially defines a passage (not shown) in communication with the cereal cavity. The passage provides access to the cereal chamber and is preferably dimensioned or otherwise provided for dispensing a cereal product stored within the cereal cavity. Optionally, the passage can also be suitable for refilling the cereal cavity from another bulk package.

In another arrangement, however, polymeric cereal container 1000 is itself suitable for use as a refill container. That is, in one exemplary application an outer container portion, such as outer container portion 802 and/or 902, for example, can be provided. The outer container portion acts as a high visibility (e.g., highly decorated, highly marked) outer shell within which an inner container portion, such as polymeric cereal container 1000, for example, is received. Due to the additional decorative detail (not shown) on the outer container portion, the same may have an increased cost associated therewith. In such an arrangement, it is then desirable to provide a lower cost refill container that can be received within the outer container portions, such as is shown, for example, in FIGS. 20 and 22. It will be appreciated that once the inner container portion is received within the outer container portion, the markings on the inner container portion will typically not be visible. Thus, it may be desirable for the inner container portion to include markings and/or decorations (not shown) of a less visible nature to reduce costs.

In use as a bulk refill container, a polymeric cereal container, such as polymeric cereal container 1000, for example, can optionally include an external support feature for supporting the polymeric cereal container, such as on a hook or hanger (not shown) in a retail store, for example. One example of a suitable external support feature is shown in FIG. 24 as a tab 1022 having a hole or opening 1024 formed therethrough. Tab 1022 can optionally be removeably secured on the polymeric cereal container, such as by using perforations 1026, for example. Another, alternate, example of a suitable external support feature is shown in FIG. 24 as an approximately U-shaped member or bail 1028 disposed along a top cap wall 1030 of cap 1002. Bail 1028 can optionally be removeably secured on top cap wall 1030 in any suitable manner, such as by including perforations 1032, for example.

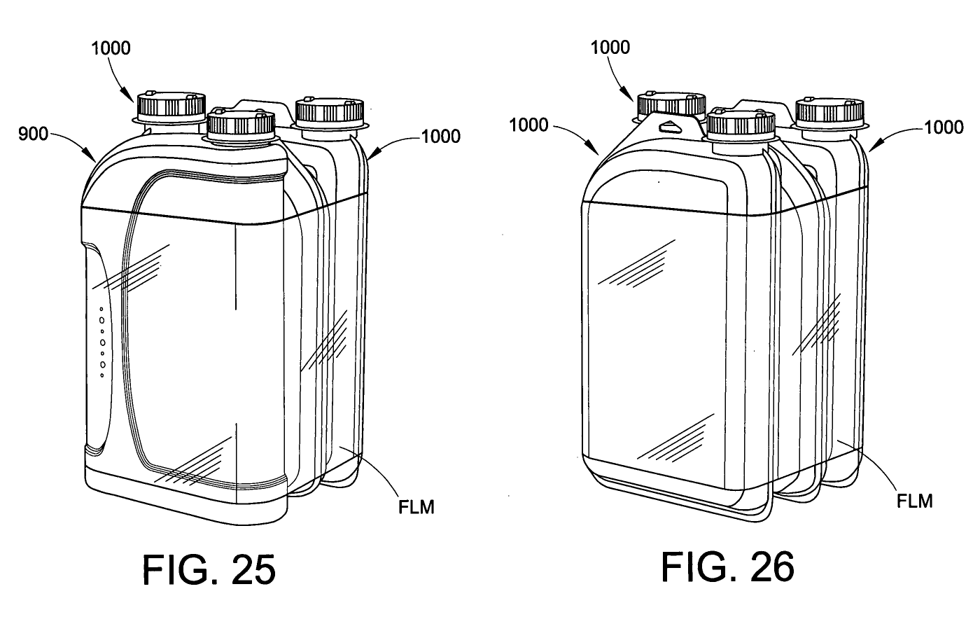

If used as a bulk refill container, polymeric cereal container 1000 can be provided as a single refill container, as shown in FIG. 24. Additionally, or in the alternative, numerous ones of polymeric cereal container 1000 can be packaged together with one or more other polymeric cereal containers, such as polymeric cereal containers 800 and/or 900, for example, as shown in FIG. 25. Such a group of polymeric cereal containers can be secured together in any suitable manner, such as by using a polymeric film FLM, for example. Alternately, numerous ones of polymeric cereal container 1000 can be packaged together by themselves, as shown in FIG. 26. Again, such a group of polymeric cereal containers can be secured together in any suitable manner, such as by using a polymeric film FLM, for example.

It is generally well recognized that food packaging applications demand the use of a packaging material that will provide a wide variety of properties and characteristics, such as approval for food contact, suitable gas and moisture barrier properties, low cost, recycleability, suitable clarity, suitable gloss/finish, desirable shrinkage/molding characteristics, printability and receptiveness to adhesive labels, for example. It is also well recognized that no single ideal material is normally available that can provide any normally desired combination of these properties and characteristics. Thus, it will be appreciated that the selection of a suitable material or combination of materials for a given packaging application will include balancing numerous desired performance properties with cost, manufacturing and other issues.

To provide a suitable packaging material for food packaging applications, it is common for suitable materials in sheet or film form to be manufactured from two or more different materials that together provide all of the desired properties and characteristics associated with the particular packaging application. Typically, multi-material sheets or films are formed by co-extrusion or other suitable processes and, thus, the various materials normally take the form of discrete layers of material of the sheet or film. For this reason, it will be recognized that manufacturing processes such as injection molding are often less well suited for producing food packaging that will utilize these multi-material sheets or films. Rather, processes such as vacuum forming and blow molding are more desirable. Utilization of one of the latter processes, in conjunction with the multi-material sheet or film, can result in a container in which each layer of material is formed continuously around and/or along approximately all of the walls of the container. It will be appreciated, however, while one or more methods of manufacture may be preferred, any suitable method or process of manufacturing can be used.

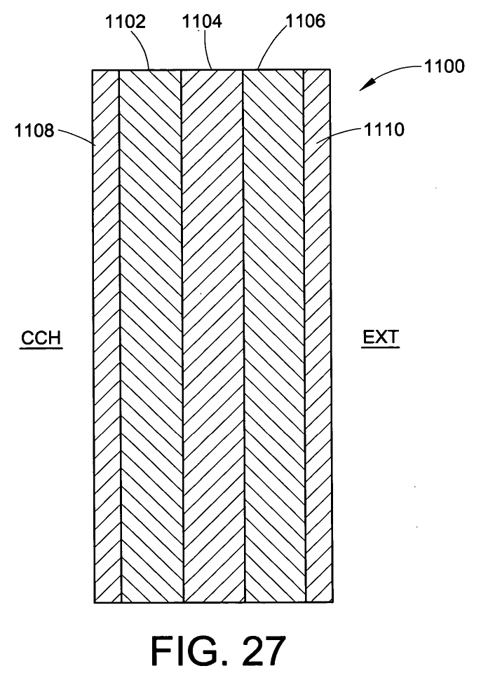

FIG. 27 shows one exemplary embodiment of a multi-material wall structure or construction 1100 suitable for use in forming a polymeric cereal container and/or a polymeric container cap in accordance with the present novel concept. For the purposes of reference and orientation of material, FIG. 27 includes a reference character CCH representing a cereal chamber of a polymeric cereal container in accordance with the present novel concept. Additionally, reference characters EXT represent the space outside or external to the container. Multi-material wall structure 1100 includes a first material 1102 and a second material 1104. One or more additional materials, such as third material 1106, can optionally be included, and in some cases ten or more materials could be used. Also, optional materials, such as fourth material 1108 and/or fifth material 1110, for example, can be formed or applied on or along wall structure 1100 after one or more manufacturing processes have been completed. For example, optional materials 1108 and/or 1110 could be applied as coatings to the sheet or film or alternately as coatings applied to the container once the same has been formed. It is to be distinctly understood that wall structure 1100 is merely exemplary of one suitable wall structure and that containers and caps in accordance with the present novel concept can be formed from different polymeric materials, combinations of polymeric materials or different grades of the same polymeric material without departing from the scope and intent of the present novel concept.

In one exemplary embodiment, first material 1102 forms the inside surface of the container and is in direct contact with the cereal product that is to be stored within cereal chamber CCH. As such, first material 1102 is preferably a grade of polymeric material that is approved for food contact. Additionally, it is desirable for at least one of the two or more materials to provide a suitable gas (e.g., oxygen and carbon dioxide) barrier to provide sufficient shelf life for the cereal product to be stored therein. Furthermore, it is desirable for at least one of the two or more materials to provide a suitable external cosmetic appearance, such as a high gloss finish, for example, and provide sufficient durability to maintain the finish for the life of the container, which may include usage as a refill container or a general storage container. Further still, it is desirable for at least one of the two or more materials, and preferably the outermost material or materials, to provide a surface receptive to printing or adhesive labels. Exemplary materials for one or more of materials 1102, 1104, 1106, 1108 and/or 1110 can include, without limitation, low density polyethylene, high density polyethylene, polypropylene, glycol-modified polyethylene terephthalate (PETG) and ethylene vinyl alcohol (EVOH), alone or in combination with one another. It is to be distinctly understood, however, that any other suitable material or materials, alone or in combination, can additionally or alternately be used.

It is also desirable for a polymeric cereal container and/or polymeric container cap in accordance with the present novel concept to have a “thin” wall structure. That is, it is desired to use a wall structure that is as thin as possible, yet thick enough to form a sturdy container that is capable of at least limited reuse. The use of thin-walled containers is desirable for a variety of reasons, including minimizing manufacturing material costs and reducing the amount of material discarded or recycled by consumers. The term thin-walled can be contrasted with known polymeric containers designed and marketed as reusable storage containers (e.g., TUPPERWARE® brand containers). Such containers are of a far more robust construction and can be considered and referred to as thick-walled containers.

Other polymeric containers are also know that are usually associated with the purchase of particular food items (e.g., COOL WHIP® brand topping containers). Once the food item has been consumed, these containers are often cleaned and kept by the consumer for storage or other uses. One reason that these containers are kept by the consumer is that the containers are capable of withstanding repeated reuse as storage containers. Such foodstuff containers are formed from material having less thickness than those designed to be reusable storage containers. However, such foodstuff containers typically have a wall thickness substantially greater than that of the containers and/or caps of the present novel concept, and can be considered and referred to as medium-walled containers.

Additionally, polymeric cereal containers and polymeric container caps are preferably formed as substantially rigid containers, as defined herein, rather than being flexible. It will be appreciated, however, that the degree to which a particular container will flex will be a combination of the structural design of the container wall or walls and of the mechanical properties of the polymeric material selected. Thus, the rigid container could be formed from a more pliant or flexible material or grade of material where substantial stiffness is provided by the geometry and/or geometric features of the wall or walls of the container, such as in container 200, for example. Whereas, a somewhat rigid material or combination of materials might be selected where a lesser degree of stiffness will be provided by the features of the wall or walls of the container, such as in container 100, for example.

In light of the foregoing, it will be appreciated that a wide variety of combinations of polymeric materials and/or grades thereof could be used to form a cereal container and/or a container cap in accordance with the present novel concept. In selecting suitable materials and/or material and design combinations, it will be desirable for the resulting container and cap to withstand repeated openings and closings without significant degradation or performance loss of the interlocking features. It will also be desirable for the resulting container to resist significant deformation or swelling, particularly along its middle, when refilled with cereal products or other suitable household items that may be stored therein, such as small toys, for example.

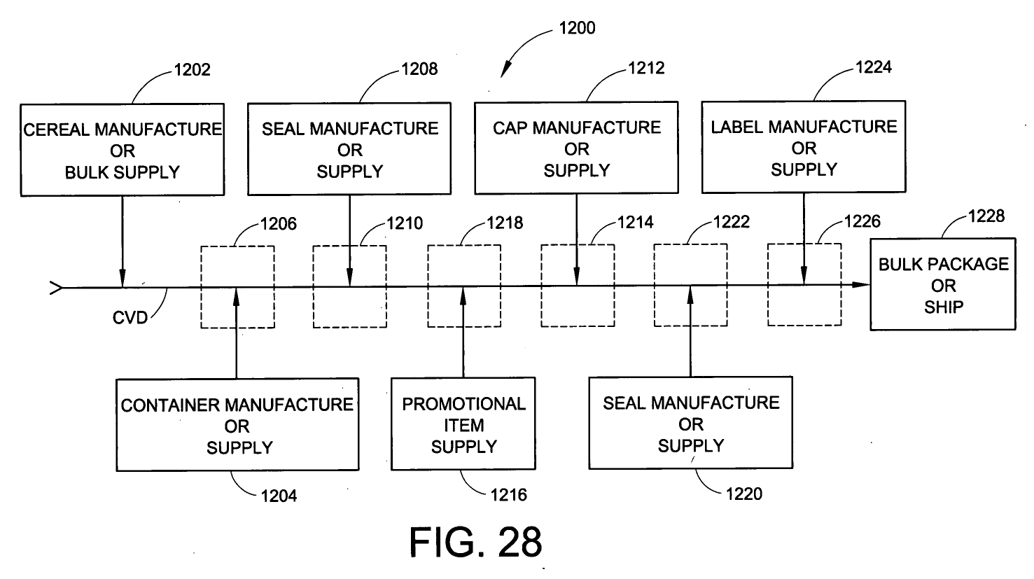

FIG. 28 is a schematic illustration of a system 1200 for packaging cereal in a polymeric cereal container in accordance with the present novel concept, and includes a cereal product source 1202, such as cereal manufacturing line or bulk cereal container, for example, adapted to output or deliver a quantity of cereal product for packaging. A polymeric cereal container source 1204 adapted to output or provide a polymeric cereal container, such as container 100, 200, 300, 400, 500, 600, 700, 800, 900 or 1000, for example, that includes a first side, a cereal chamber at least partially formed by the first side and a container opening in communication with the cereal chamber. One example of a suitable polymeric cereal container source 1204 is a storage area housing a quantity of pre-manufactured polymeric cereal containers. Another example of a suitable polymeric cereal container source is an in-house or in-line molding machine, such as a blow molding machine or an injection molding machine, for example, adapted to produce polymeric cereal containers. A filling station 1206 is in communication with cereal product source 1202 and receives a quantity of cereal product therefrom. Additionally, filling station 1206 is in communication with container source 1204 and receives a polymeric cereal container therefrom. The filling station is adapted to position the polymeric cereal container and dispense the quantity of cereal product into the cereal chamber of the polymeric cereal container. Thus, filling station 1206 outputs a polymeric-cereal container that is filled with a quantity of cereal product.

A sealing member source 1208 is adapted to output or otherwise supply sealing members, such as sealing members 176 or 264, for example, suitable for forming a seal along or across the container opening of the filled polymeric cereal container. A sealing station 1210 is in communication with filling station 1206 and receives the filled polymeric cereal containers therefrom. The sealing station is also in communication with sealing member source 1208 and receives sealing members therefrom. Sealing station 1210 is adapted to position the sealing member along or across the container opening of the filled container and secure the same thereon in a suitable manner.

A container cap source 1212 is adapted to output or otherwise provide polymeric container caps, such as container cap 102, 202, 302, 402, 502, 602, 702, 808, 908 or 1002 for example, suitable for being secured along or across the container opening of a sealed polymeric cereal container. One example of a suitable polymeric container cap source 1212 is a storage area housing a quantity of pre-manufactured polymeric container caps. Another example of a suitable polymeric container cap source is an in-house or in-line molding machine, such as a blow molding machine or an injection molding machine, for example, adapted to produce polymeric container caps. A capping station 1214 is in communication with sealing station 1210 and receives sealed polymeric cereal containers therefrom. The capping station is also in communication with container cap source 1212 and receives container caps therefrom. Capping station 1214 is adapted to position the polymeric container cap on the sealed polymeric cereal container and secure the polymeric container cap across the container opening, such as by snap fitting interlocking features together or threadably engaging complimentary threads, for example.

Optionally, system 1200 can include a promotional item source 1216 adapted to output or supply promotional items for inclusion on or with the packaged cereal product. If a promotional item source is included,.an optional item insertion station 1218 can also be included that is in communication with the promotional item source and receives promotional items therefrom. Optional item insertion station 1218 is also shown as being in communication between sealing station 1210 and capping station 1214 and, as such; can receive sealed polymeric cereal containers before the same are capped at capping station 1214. However, it is to be distinctly understood that the item insertion station could alternately be positioned in any other suitable place in the system. Item insertion station 1218, if provided, is adapted to position the promotional item or items to be included with the packaged cereal product in abutting engagement with the sealed polymeric cereal container, such as along the sealing member, for example. The capping or other operation can then secure the promotional item in place, such as by forming a storage compartment 182, for example.

System 1200 can also optionally include a second sealing member source 1220 adapted to output sealing members, such as sealing member 178, for example, suitable for securing the polymeric container cap on the sealed polymeric cereal container. It will be appreciated that either or both of the foregoing sealing members of can also include tamper evident materials. A second sealing station 1222 is in communication with second sealing member source 1220 for receiving the sealing members therefrom. The second sealing station is also in communication with capping station 1214 and receives capped polymeric cereal containers therefrom. Second sealing station 1222 is adapted to secure the second sealing member along at least a portion of the polymeric container cap or the polymeric cereal container, and preferably a portion of both.

System 1200 can further include an optional label source 1224 adapted to output or supply labels, such as cover CVR, for example, for securement along at least one of the polymeric container cap or the polymeric cereal container. If the optional label source is provided, a labeling station 1226 can also optionally be provided and is in communication with label source 1224 for receiving labels therefrom. The optional labeling station is also in communication with capping station 1214 or optionally with second sealing station 1222, if provided, for receiving capped and/or sealed polymeric cereal containers therefrom. Labeling station 1226 is adapted to apply one or more labels to and/or along at least one of the polymeric container cap and/or the polymeric container. After exiting capping station 1214 and optionally one of stations 1222 and/or 1226, the polymeric cereal container can be conveyed to a further downstream packaging or shipping station 1228.

The various components of system 1200 can be in communication with one another in any suitable manner or combination of manners, indicated generally as conveying devices CVD in FIG. 20. For example, the quantity of cereal product could be delivered using a substantially enclosed chute along which the quantity of cereal product will flow under the influence of gravity or a vacuum. As another example, any of the various packaging components, such as a polymeric cereal container, a polymeric container cap, a sealing member or a label, for example, can be transported on suitable conveyors.

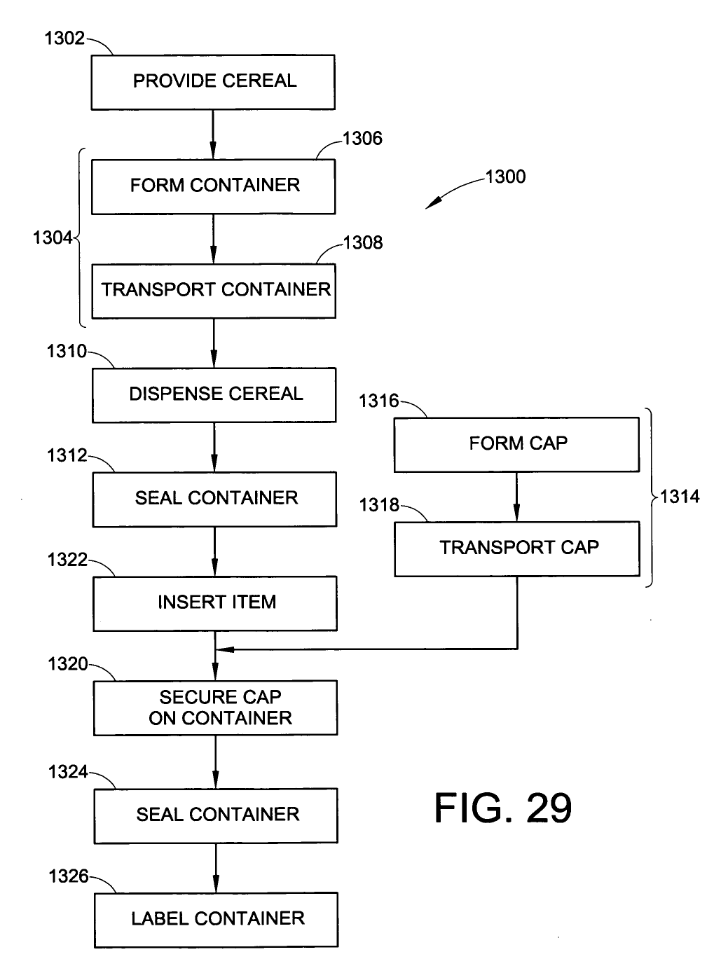

FIG. 29 illustrates one exemplary embodiment of a method 1300 of packaging cereal that includes an initial step 1302 of providing a quantity of a cereal product to be packaged. In one exemplary embodiment, step 1302 could be performed at least in party by cereal product source 1202, for example.

Another step 1304 includes providing a polymeric cereal container, such as cereal container 100, 200, 300, 400, 500, 600, 700, 800, 900 or 1000, for example, that is to be filled with at least a portion of the quantity of cereal product provided in step 1302. In one exemplary embodiment, step 1304 optionally includes a step 1306 of forming a polymeric cereal container and a step 1308 of transporting the container to a cereal dispensing or filling station. In one exemplary method, step 1306 of forming the polymeric cereal container is performed by molding, such as blow molding or injection molding, for example, the polymeric cereal container. This can be performed in-house or in-line with a cereal production or filling line so that the container is molded just prior to being filled by with a quantity of a cereal product. In such an exemplary method, step 1308 could include transporting the polymeric cereal container along a conveyor to a filling station, such as filling station 1206 in FIG. 28, for example. In one exemplary embodiment, steps 1306 and 1308 could be performed at least in part by polymeric cereal container source 1204, for example.

Another step 1310 includes filling or otherwise dispensing the quantity of cereal product provided in step 1302 into the cereal chamber of the polymeric cereal container provided in step 1304 through the container opening therein. In one exemplary embodiment, this step can be performed by filling station 1206. A further step 1312 includes sealing the container opening using a suitable sealing member. In one exemplary embodiment, this step can be performed by sealing station 1210.

Still a further step 1314 includes providing a polymeric container cap for securement on the polymeric cereal container across the sealed container opening thereof. Step 1314 can optionally include steps 1316 of forming a polymeric container cap and step 1318 of transporting the polymeric container cap. In one exemplary method, step 1316 of forming the polymeric container cap is performed by molding, such as blow molding or injection molding, for example, the polymeric container cap. This can be performed in-house or in-line with a cereal production or filling line so that the container cap is molded just prior to being secured on the polymeric cereal container. In such an exemplary method, step 1318 could include transporting the polymeric container cap along a conveyor to a capping station, such as capping station 1214 in FIG. 28, for example. In one exemplary embodiment, steps 1316 and 1318 could be performed at least in part by polymeric container cap source 1212, for example.

Another step 1320 includes securing the polymeric container cap on the sealed polymeric cereal container. In one exemplary embodiment, step 1320 could be performed by capping station 1214. An optional step 1322 includes inserting a promotional item in, on or along the polymeric cereal container. In one exemplary embodiment, this optional step could be performed by a combination of promotional item source 1216 and item insertion station 1218. A further optional step 1324 includes sealing the polymeric cereal container and polymeric container cap together using a second sealing member. In one exemplary embodiment, step 1324, if performed, could be performed by second sealing member source 1220 and second sealing station 1222. Still a further step 1326 includes applying one or more labels on or along the polymeric cereal container and/or polymeric container cap. In one exemplary embodiment, optional step 1326, if performed, could be performed by label source 1224 and/or labeling station 1226.

While the subject novel concept has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles of the subject novel concept. Obviously, modifications and alterations will occur to others upon reading and understanding the preceding detailed description. Accordingly, it is to be distinctly understood that the foregoing descriptive matter is to be interpreted merely as illustrative of the present novel concept and not as a limitation. As such, it is intended that the subject novel concept be construed as including all such modifications and alterations insofar as they come within the scope of the appended claims and any equivalents thereof.

1. A linerless cereal container comprising:
a first side wall formed from a polymeric material and including a first opening wall portion;
a second side wall formed from said polymeric material, said second side wall spaced from said first side wall and at least partially defining a cereal chamber therebetween, said second side wall including a second opening wall portion spaced from said first opening wall portion and at least partially defining a container opening therebetween;
at least one end wall formed from said polymeric material, said at least one end wall extending between said first side wall and said second side wall and including an end opening wall portion extending between said first and second opening wall portions; and, a bottom wall formed from said polymeric material and extending between at least two of said first side wall, said second side wall or said end wall.

2. A linerless cereal container according to claim 1 further comprising a container cap formed from a polymeric material and including an end wall and a side wall, said end wall adapted to extend at least partially across said container opening, and said side wall extending peripherally along at least a portion of said end wall and adapted to engage at least one of said first opening wall portion, said second opening wall portion or said end opening wall portion.

3. A linerless cereal container according to claim 2 further comprising a sealing member that is one of extending across a portion of said container opening or extending along said side wall of said container cap.

4.-6. (canceled)

7. A linerless cereal container according to claim 1, wherein said first side wall includes a contoured surface and said first opening wall portion extends from said contoured surface.

8. A linerless cereal container according to claim 7, wherein said first opening wall portion includes a substantially planar portion adjacent said contoured surface and said first opening wall portion extends along said substantially planar portion.

9. A linerless cereal container according to claim 7, wherein said contoured surface of said first side wall is a first contoured surface and said second side wall includes a second contoured surface with said second opening wall portion extending from said second contoured surface.

10. A linerless cereal container according to claim 9, wherein one of said at least one end walls includes an end contoured surface.

11. A cereal container storing a quantity of dry cereal, said cereal container comprising:
a container body formed from a rigid polymeric material and including a first side, a cereal chamber at least partially formed by said first side and receiving said quantity of dry cereal, and a container opening at least partially defined by said first side;
a container cap formed from a rigid polymeric material and including a closed end, an opposing open end and a side wall extending between said open and closed ends, said container cap received on said container body such that said closed end extends across at least a portion of said container opening; and,
a sealing member that is one of extending across at least a portion of said container opening between said container body and said container cap or extending along said side wall of said container cap.

12. A cereal container according to claim 11, wherein said cereal chamber receives said quantity of dry cereal such that a portion of said quantity of dry cereal is in direct contact with said first side.

13.-22. (canceled)

23. A cereal container according to claim 11 further comprising a storage compartment on at least one of said container body, said container cap or said sealing member.

24. A cereal container according to claim 23, wherein said container cap includes a cap chamber formed by said closed end and said side wall, and said storage compartment is formed within said cap chamber.

25. A cereal container according to claim 24, wherein said storage compartment is at least partially formed by said sealing member.

26. A cereal container according to claim 11 further comprising a second side spaced from said first side.

27. A method of packaging cereal comprising steps of:
a) providing a cereal container formed from a polymeric material, said cereal container including a first wall, a cereal chamber at least partially formed by said first wall, and a container opening at least partially defined by said first wall;
b) providing a quantity of cereal and dispensing said quantity of cereal into said cereal chamber of said cereal container through said container opening;
c) providing a container cap formed from a polymeric material; and,
d) securing said container cap on said cereal container across at least a portion of said container opening.

28. (canceled)

29. (canceled)

30. A method according to claim 27, wherein step c) includes dispensing said quantity of cereal into said cereal chamber such that a portion of said quantity of cereal is in direct contact with said first wall.

31. A method according to claim 27 further comprising providing a label and securing said label on one of said cereal container or said container cap.

32. A method according to claim 27 further comprising providing a sealing member and securing said sealing member across at least a portion of said container opening.

33. A method according to claim 27 further comprising providing a sealing member and securing said sealing member along at least a portion of said container cap.

34. A method according to claim 27 further comprising providing a storage chamber along one of said cereal container and said container cap and segregated from said cereal chamber.

35. A method according to claim 34 further comprising providing at least one of an additional cereal item or a non-cereal item and securing said at least one item within said storage compartment.

36.-38. (canceled)

39. A method according to claim 27, wherein step a) includes providing a cereal container further comprising a second wall spaced from said first wall.

40. (canceled)

41. A method according to claim 39, wherein step a) includes forming a first contoured surface along said first wall.

42. A method according to claim 41, wherein step a) includes forming a second contoured surface on one of said first wall and said second wall.

43. A cereal packaging system comprising:
a cereal product source adapted to output a quantity of cereal product;
a polymeric cereal container source adapted to output a polymeric cereal container including a first wall, a cereal chamber at least partially defined by said first wall and a container opening at least partially defined by said first wall;
a filling station in communication with said cereal product source and said polymeric cereal container source to respectively receive said quantity of cereal product and said polymeric cereal container, said filling station adapted to dispense said quantity of cereal product into said cereal chamber of said polymeric cereal container through said container opening;
a sealing member source adapted to output a sealing member;
a container sealing station in communication with said filling station and said sealing member source to respectively receive a filled polymeric cereal container and said sealing member, said container sealing station adapted to apply said sealing member along said filled polymeric cereal container;
a container cap source adapted to output a polymeric container cap; and,
a capping station in communication with said container sealing station and said container cap source to respectively receive a sealed polymeric cereal container and said container cap, said capping station adapted to secure said container cap on said sealed polymeric cereal container.

44. A cereal packaging system according to claim 43, wherein said polymeric cereal container source includes a molding machine adapted to form said polymeric cereal container.

45. A cereal packaging system according to claim 43, wherein said polymeric container cap source includes a molding machine adapted to form said polymeric container cap.

46. A cereal packaging system according to claim 43 further comprising a promotional item source adapted to output a promotional item and an item insertion station in communication with said sealing station and said promotional item source to respectively receive a sealed polymeric cereal container and said promotional item, said item insertion source adapted to position said promotional item in abutting engagement with said sealed polymeric cereal container.

47. A cereal packaging system according to claim 43 further comprising a label source adapted to output a label and a label application station in communication with said capping station and said label source to respectively receive a capped polymeric cereal container and said label, said label application station adapted to apply said label to one of said polymeric cereal container or said polymeric container cap.

48. A cereal container assembly comprising:
a first quantity of dry cereal;
a first container body formed from a rigid polymeric material and including a first side, a cereal chamber at least partially formed by said first side and receiving said first quantity of dry cereal, and a first container opening at least partially defined by said first side;
a container cap formed from a rigid polymeric material and including a closed end, an opposing open end and a side wall extending between said open and closed ends, said container cap received on said first container body such that said closed end extends across at least a portion of said first container opening;
a sealing member that is one of extending across at least a portion of said first container opening between said first container body and said container cap or extending along said side wall of said container cap; and,
a cereal product refill secured on said first container body and including a second quantity of dry cereal.

49. A cereal container assembly according to claim 48, wherein said cereal product refill includes a low-cost polymeric bag containing said second quantity of dry cereal.

50. A cereal container assembly according to claim 48, wherein said cereal product refill is secured to said first container body using a polymeric film extending around said cereal product refill and said container body.

51. A cereal container assembly according to claim 48 further comprising a second container body formed from a rigid polymeric material and including a second side, a container chamber at least partially formed by said second side, and a second container opening providing access to said container chamber for receiving said first container body therein.

52. A cereal container assembly according to claim 51 further comprising a cover formed from a rigid polymeric material and disposed along said second container body at least partially across said second container opening.

53. A cereal container assembly according to claim 51, wherein said cereal product refill includes another one of said first container body containing said second quantity of dry cereal.

54.-64. (canceled)
